(19) United States
(12) Patent Application Publication
(10) Pub. No.: US 2012/0166643 A1
(43) Pub. Date: Jun. 28, 2012

(54) SYSTEMS AND METHODS FOR CONTROLLING AND MANAGING PERSONAL DATA COMMUNICATIONS

(75) Inventor: George P. Smith, Cary, NC (US)

(73) Assignee: CUSTOMIZED TECHNOLOGY SERVICES, INC., Cary, NC (US)

(21) Appl. No.: 13/337,191

(22) Filed: Dec. 26, 2011

Related U.S. Application Data
(60) Provisional application No. 61/427,216, filed on Dec. 27, 2010.

(51) Int. Cl. G06F 15/173

(52) U.S. Cl. 709/225

(57) ABSTRACT

Disclosed herein are systems and methods for controlling and managing personal data communications. According to an aspect, a method may be computer-implemented for controlling data communications. The computer-implemented method may include receiving and storing data from at least one electronic device. Further, the computer-implemented method may include controlling access to the data using at least one user control space. The computer-implemented method may also include managing the data using the at least one user control space. Further, the computer-implemented method may include communicating with at least one other electronic device using the at least one user control space.

### CROSS REFERENCE TO RELATED APPLICATION

This application claims the benefit of U.S. provisional patent application Ser. No. 61/427,216, filed Dec. 27, 2010; the disclosure of which is incorporated herein by reference in its entirety.

### TECHNICAL FIELD

The presently disclosed subject matter relates to network communications. Particularly, the presently disclosed subject matter relates to controlling and managing personal data communications in network communications.

### BACKGROUND

Use of various communication channels, such as email, text messaging, and voice communications, have become common due to the widespread availability of connectivity to various communications networks, such as the Internet. An end user may utilize such communication channels via a suitable communications terminal, such as a computer, a mobile telephone, an e-reader, or any other networked computing device.

At least one difficulty with an end user utilizing such a variety of communication channels is that the data can become widespread among several different servers connected to the Internet, for example. For example, current mobile messaging software and computer email software do not provide the end user with the ability to manage his or her data at a single location. Particularly, for example, mobile identifiers contain the end user mobile telephone number, and emails contain the name of the computer server that manages the end user emails. Thus, such communications are tied to a particular server.

In view of the foregoing, it is desired to provide end users with improved systems and methods for controlling and managing their personal data and associated communications in network communications.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

The presently disclosed subject matter provides end users with an option to send their mobile messages, mobile emails, and computer emails, including attachments, to an alternate location enabled with user management of all their mobile messages, computer emails, and the like. As a result, the end users will no longer need to login to different accounts, and use different interfaces to manage their messages and data. The systems and methods disclosed herein can provide an end user with an option to use a single login identifier (ID) for both mobile devices and computers.

In accordance with embodiments of the presently disclosed subject matter, mobile users who are also computer users are provided with an option to access one location to manage all their mobile messages, computer emails, and the like.

In accordance with other embodiments, end users are provided with an option to use a login ID free of personal and computer information for use in managing their messages and data.

In accordance with other embodiments, end users can use a single ID to login to manage their messages and data.

In accordance with other embodiments, ends users are provided with an option to communication in a single operation, messages and data to both mobile devices and computers.

In accordance with other embodiments, ends users are provided with an option to communicate messages and data with notifications and alerts to recipients' mobile devices and computers. Notifications and alerts include a text message to mobile text-enabled devices, an email, or a pre-recorded voice message to mobile voice-enabled devices or a pre-recorded message to a land telephone. It should be noted that the land call can be local or international.

In accordance with other embodiments, users may have an option to communicate their messages and data in a “ready-to-view state.” In this state, inbox folders, trash folders, spam folders, and attachment to open and view, as with current email applications, will not be needed. A user may simply select a type of message or data to view (i.e., show text messages, images, video, audio, PDF documents, EXCEL documents, and the like).

Disclosed herein are systems and methods for controlling and managing personal data communications. According to an aspect, a method may be computer-implemented for controlling data communications. The computer-implemented method may include receiving and storing data from at least one electronic device. Further, the computer-implemented method may include controlling access to the data using at least one user control space. The computer-implemented method may also include managing the data using the at least one user control space. Further, the computer-implemented method may include communicating with at least one other electronic device using the at least one user control space.

Additional details and various other embodiments of the present disclosure are described in the Detailed Description section and the appended drawings.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example system for controlling and managing personal data communication in accordance with embodiments of the present disclosure;

FIG. 2 is a flowchart of an example method for controlling data communication in accordance with embodiments of the present disclosure;

FIG. 3 is a flowchart of an example method of setup and initialization in accordance with embodiments of the present disclosure;

FIGS. 3A-3F, 4A and 4B, and 5A-5C are flowcharts of example methods of end user subscription template implementation according to embodiments of the present disclosure;

FIG. 6A-6C illustrates a flowchart of an example method for controlling data communications according to embodiments of the present disclosure;

FIG. 7A-7C illustrates a flowchart of an example method for controlling data communications according to embodiments of the present disclosure;

FIG. 8A and 8B illustrates a flowchart of an example method for controlling data communications according to embodiments of the present disclosure;

FIG. 9A-9C illustrates a flowchart of an example method for controlling data communications according to embodiments of the present disclosure;

FIG. 10A-10C illustrates a flowchart of an example method for controlling data communications according to embodiments of the present disclosure;

FIG. 11 illustrates a flowchart of an example method for implementing applications in accordance with embodiments of the present disclosure;

FIG. 12A-12C illustrate a flowchart of an example method according to embodiments of the present disclosure;

FIG. 13A-13C illustrate a flowchart of an example method according to embodiments of the present disclosure;

FIG. 14 illustrates a flow chart of another example method according to embodiments of the present disclosure;

FIG. 15 illustrates a file diagram of a message and data queue in accordance with embodiments of the present disclosure; and

FIGS. 16-20 illustrate various example screen displays presented to an end user of an electronic device accessing a server in accordance with embodiments of the present disclosure.

### DETAILED DESCRIPTION

The presently disclosed subject matter is described with specificity to meet statutory requirements. However, the description itself is not intended to limit the scope of this patent. Rather, the inventor has contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Exemplary solutions provided by embodiments of the present disclosure include, but are not limited to: creating an online user control space to manage messages and data; utilizing databases for users configuration; utilizing databases for data and message servers configuration, mobile devices, and computers configuration; creating a user interface for the user control space and providing the user with options; providing a set of commands the user can use to control the action to be taken when messages and data are communicated; collecting information from end users for user configuration; collecting information from end users for their mobile devices and computers, providing the information cannot be obtained automatically from the mobile device or computer; and creating a compatibility pipeline to current mobile and computer messages, and allowing email users to allow gradual migration to the systems and methods disclosed herein. Other solutions provided by the presently disclosed subject matter will become apparent to those of skill in the art while reading the present disclosure.

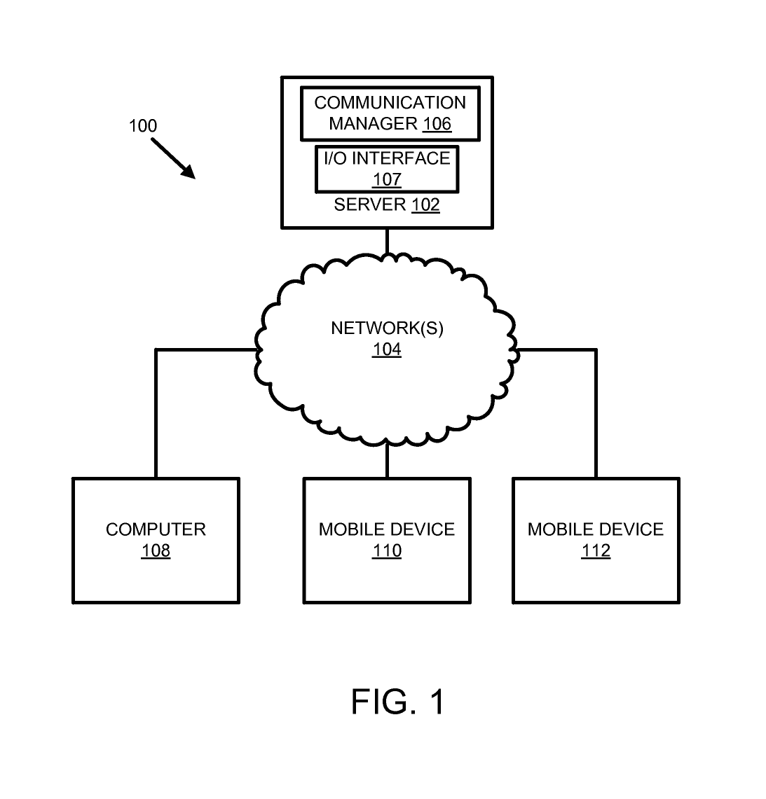

FIG. 1 illustrates a block diagram of an example system 100 for controlling and managing personal data communication in accordance with embodiments of the present disclosure. Referring to FIG. 1, the system may include a web-enabled server 102 configured for communications with one or more networks 104. The network(s) 102 may include, but is not limited to, the Internet, a public switch telephone network (PSTN), a cellular network, and/or any other suitable network. Alternatively, the server 102 may be any suitable type of server or multiple servers or computing devices configured for managing and controlling data communications among a plurality of end users. The server 102 may be configured for communicating over any communications network, including wired, wireless, local area networks (LANs), wide area networks (WANs), and mobile networks. The server 102 may include hardware, firmware, software, and/or combinations thereof

The server 102 may include communication manager 106 and a processing system 106, as described in more detail herein for implementing one of more embodiments of the present disclosure. The communication manager 106 may be configured to execute and respond to transaction requests. The communication manager 106 may be implemented by hardware, software, firmware, and combinations thereof. The server 102 may include an input/output (I/O) interface configured to communicate with the network(s) 104. In accordance with embodiments of the present disclosure, the communication manager 106 may be configured to: receive and store data from electronic devices; control access to the data using user control spaces; manage the data using the control spaces; and communicate with the electronic devices using the user control spaces.

As referred to herein, an “electronic device” may be a computer, mobile device, any computing device, or any terminal of a communications network. An electronic device may include at least one processor and memory and may include one or more user interfaces for interaction with a user.

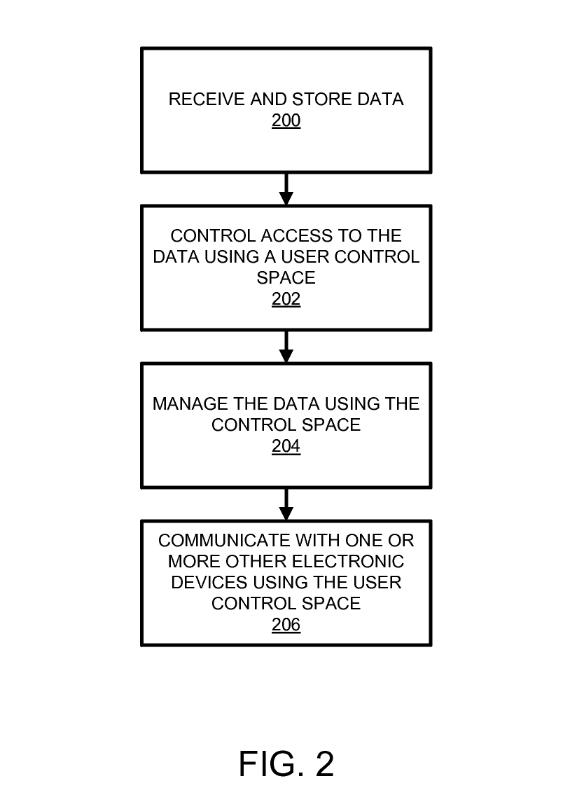

FIG. 2 illustrates a flowchart of an example method for controlling data communication in accordance with embodiments of the present disclosure. For purposes of illustration, the method of FIG. 2 is described as being implemented by the server 102, although the method may be implemented by any suitable computing or electronic device. Referring to FIG. 2, the method includes receiving and storing data from an electronic device (step 200). For example, referring to FIG. 1, a computer 108 (or mobile device 110, mobile device 112, or any other computing device configured to communicate with the network(s) 104) may communicate data to the server 100 via the network(s) 104. In this example, I/O interface 104 may receive the data and send the data to communication manager 106 of the server 102 for storage in memory of the server 102. The storage area of the data in the memory may be accessed for storage of data and for retrieval of data by use of architected identification that does not include personal or computer-identifiable information. The architected identification may be used by an electronic device, such as the computer 108, mobile device 110, and mobile device 112, for accessing the user control space of the server 100, which may include the memory space for storing the associated end user's data.

The method of FIG. 2 includes controlling access to the data using the control space (step 204). For example, the communication manager 106 may receive architected identification for enabling a user to access and/or use control space of another user. Some data stored in the control space may require use of multiple identifications. It is noted that the architected identification includes no personal or information that identifies an electronic device. The architected identification may be received from an electronic device via the network(s) 104, verified for use in accessing the control space, and permission granted to access the control space in response to verifying the architected identification.

The method of FIG. 2 includes managing the data using the user control space (step 204). For example, data may be added or removed from the control space. Further, the method of FIG. 2 includes communicating with one or more other electronic devices using the user control space (step 206). For example, simultaneous communication between two or more electronic devices may be implemented using the control space. Additional details of this example method are disclosed herein.

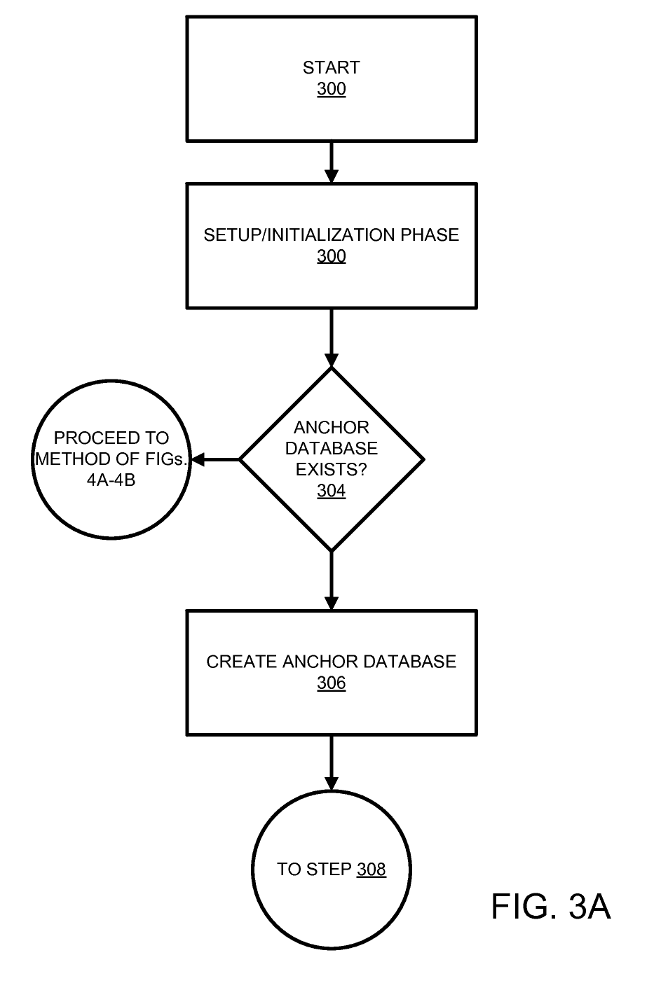

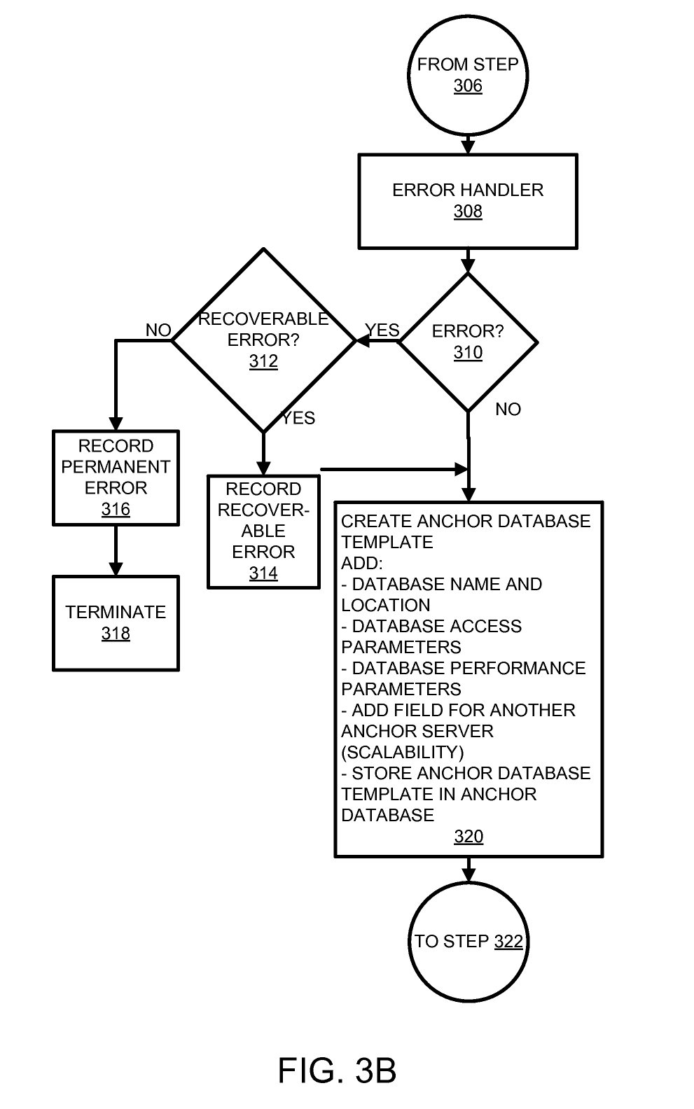

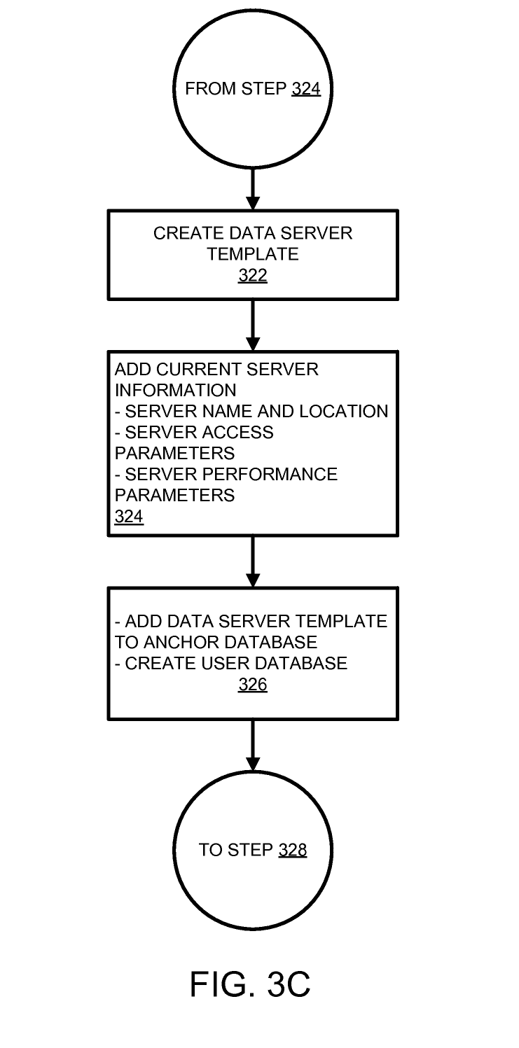

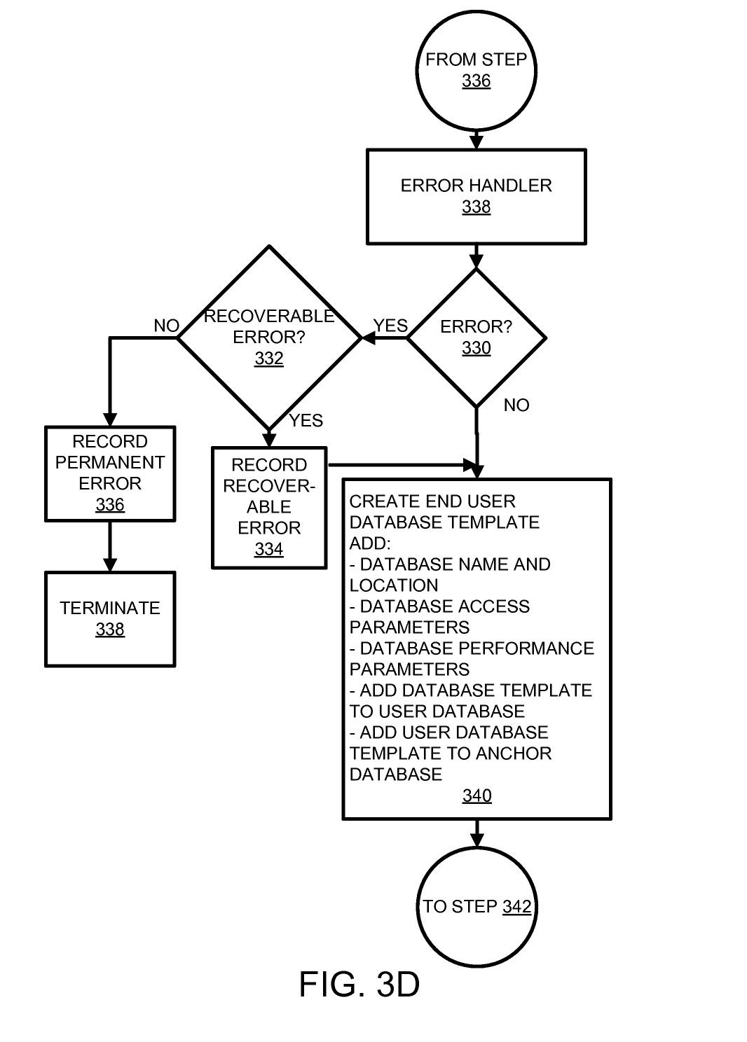

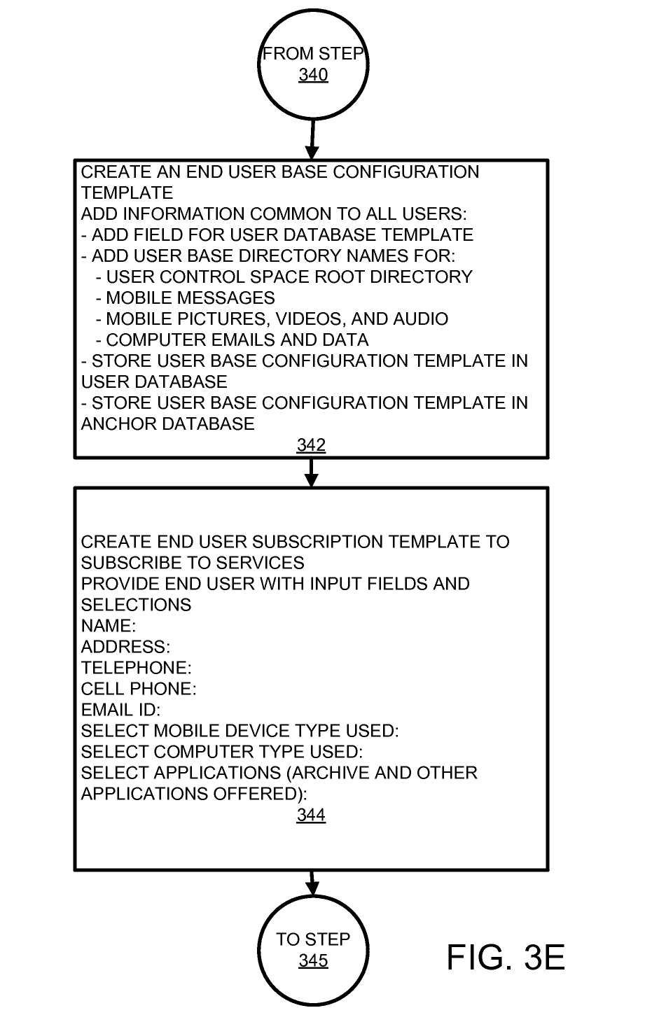

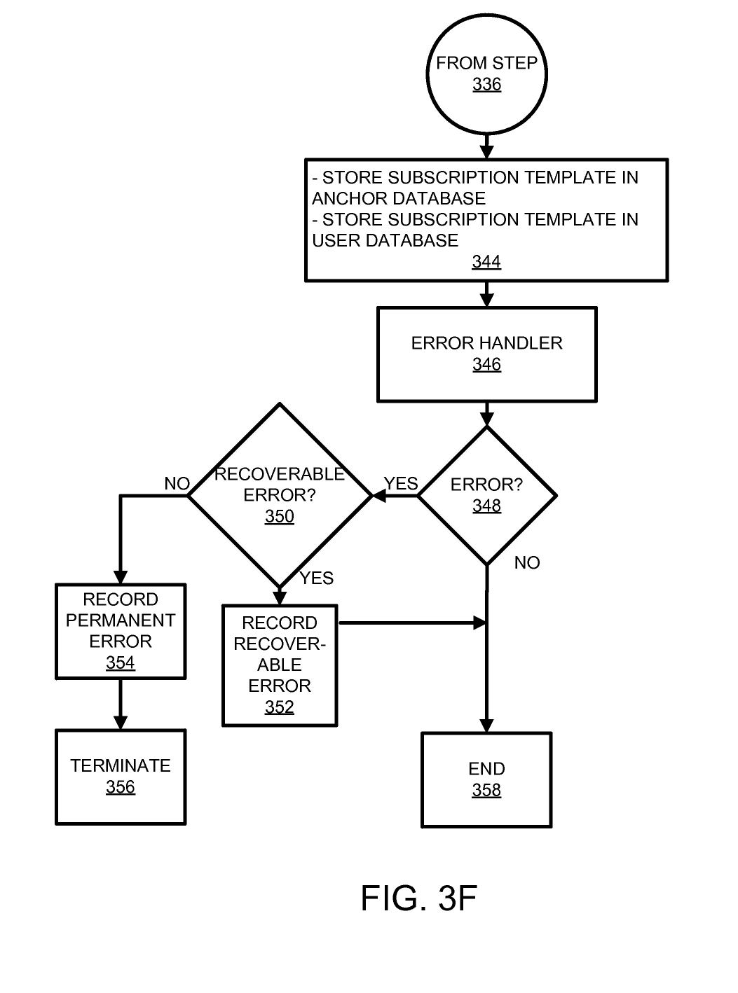

System and method embodiments disclosed herein may be implemented in various phases or stages described herein below. For example, FIGS. 3-16 depict flowcharts for implementing various embodiments in accordance with the present disclosure. Generally, phase I described below may be a setup and initialization phase. Phase II described below may be an end user subscription template phase. Phase III described below may be an end user single control space template phase. Phase IV described below may be an end user single control space options phase. Phase V described below may be an applications phase. Phase VI described below may be an online archive phase. Phase VII described below may be an error handling phase. Phase VIII described below may be a recipient notifications phase. These phases are described in more detail herein below.

### Phase I—Setup and Initialization

Example phase I may be used to create and initialize an environment for an end user of mobile text messages, images, video, audio messages, data (e.g., email attachments) and emails to subscribe to a system (e.g., software) for controlling and managing such data in a control space in accordance with embodiments of the present disclosure. As an example, use of each functional element may be subscribed to a fee basis or without charge. For example, an application can be offered free, or for a fee, online archiving and the like.

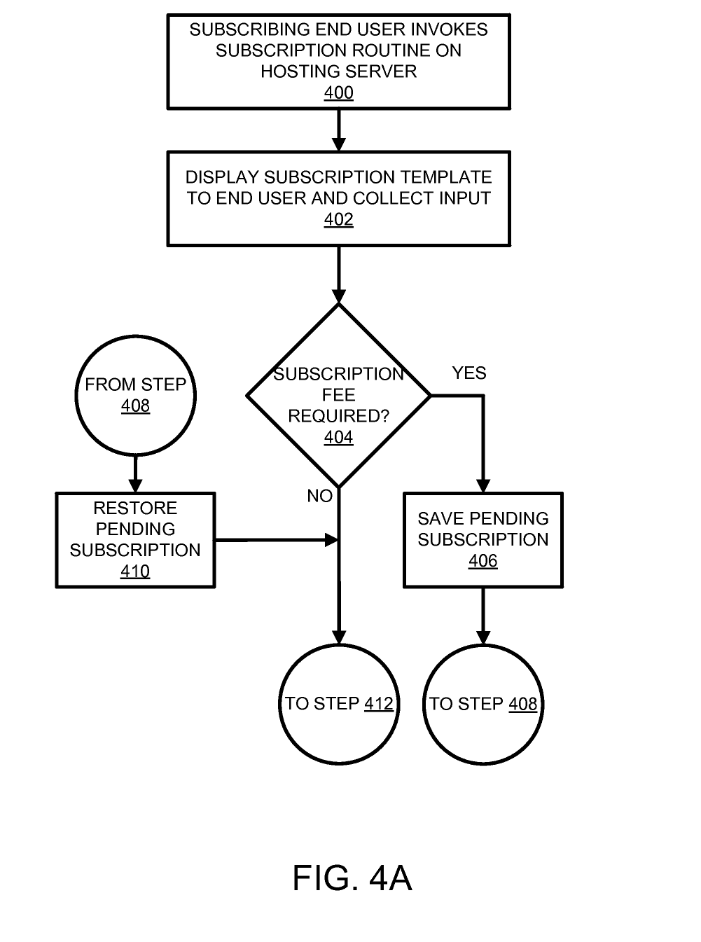

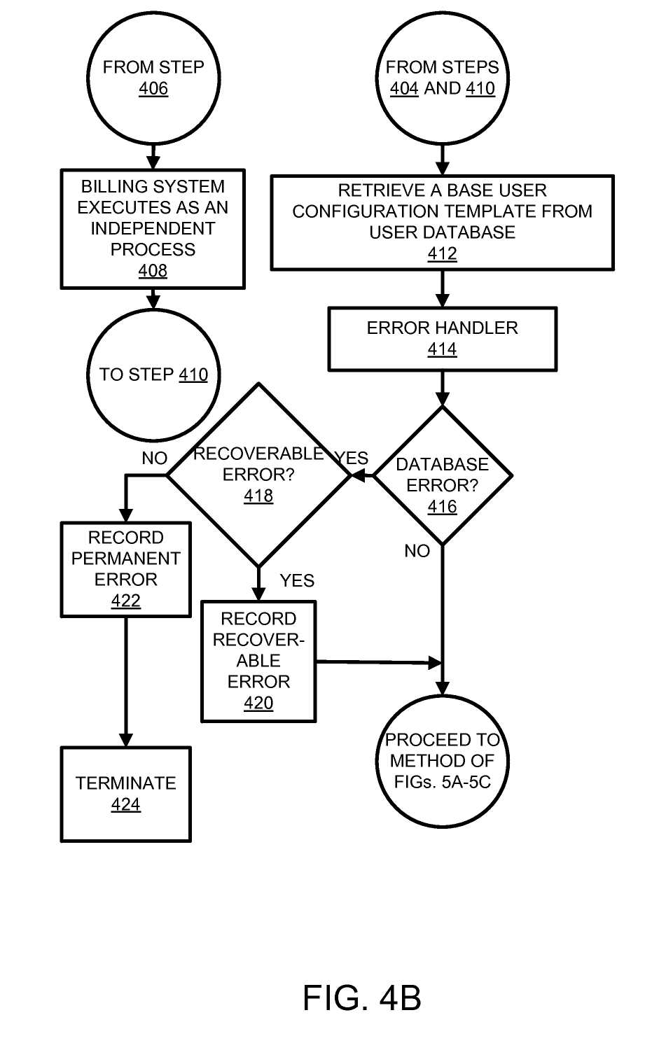

As an example, the setup and initialization phase is depicted in FIGS. 3A-3F and 4A-4B. FIG. 3 illustrates a flowchart of an example method of setup and initialization in accordance with embodiments of the present disclosure. This example method may be implemented, for example, by the server 102 shown in FIG. 1 or any other suitable electronic device. Generally, one or more databases are created and stored in server memory or another memory accessible by the server 102. These databases include, but are not limited to, an anchor database, a server database, and a user database. The anchor database may contain information about itself, the server database, and the user database. It may be located at a different server than the server database, and the user database. The server database and the user database may be located at the server implementing the example method, such as, for example, the server 100 shown in FIG. 1. These databases are generally referred to as distributed databases.

In the event the server database or the user database becomes inoperable, the anchor database can be used as a temporary server database, and can also be used to recreate a user database and a user environment. This strategy can greatly reduce the length of time users' service is interrupted at a specific hosting server.

It should be noted that the anchor database is not required, but can be beneficial.

The server database can contain information about itself, and the user database. The server database is not required, but can be beneficial. In the event the hosting server nears to reaching an overload threshold, users can quickly be offloaded to another server.

The user database may contain information about itself, and the users at a specific host. This database may be required for protection of users that have to be locked and unlocked for updates.

Now referring to FIGS. 3A-3F, the method may begin at step 300 and the setup/initialization phase may begin (step 302). Subsequently, it is determined whether an anchor database exists (step 304). In response to determining that an anchor database does not exist, creation of an anchor database is initiated (step 306). In response to determining that an anchor database exists, the server may proceed to step 400 of FIGS. 4A-4B described in more detail herein below. Subsequent to step 306, an error handler may be initiated (step 308) and may determine whether an error has occurred (step 310). Example errors include, but are not limited to, anchor database cannot be created (permanent error) and anchor database busy—automatic retry until not busy (recoverable error). In response to determining that an error has occurred, it is determined whether the error is a recoverable error (step 312). In response to determining that the error is recoverable at step 312, the recoverable error may be recorded (step 314). On the other hand, in response to determining that the error is not recoverable, the error may be recorded as a permanent error at step 316 and the method may terminate at step 318.

Returning to step 310, the method may proceed to step 320 in response to determining that there is no error. Further, the method may proceed to step 320 subsequent to recording the recoverable error at step 314. At step 320, an anchor database template is created and may include information such as, but not limited to, name, location, access parameters, performance parameters, and one or more fields for another anchor server for scalability. The anchor database template may be stored in a database for anchor data.

At step 322 shown in FIG. 3C, a database server template may be created. Current server information may be added to the data server template (step 324). Such information may include, but is not limited to, server name, server location, server access parameters, and server performance parameters. Subsequently, at step 326, the data server template may be added to the anchor database, and a user database may be created.

At step 328 shown in FIG. 3D, an error handler may be initiated. Subsequently, the error handler may determine whether an error has occurred (step 330). Example errors include, but are not limited to, cannot write template to server (database server, data server, etc) database (permanent error), and timed out attempting to write template to server—automatic retry (recoverable error). In response to determining that an error has occurred, it is determined whether the error is a recoverable error (step 332). In response to determining that the error is recoverable at step 332, the recoverable error may be recorded (step 334). On the other hand, in response to determining that the error is not recoverable, the error may be recorded as a permanent error at step 336 and the method may terminate at step 338.

Returning to step 330, the method may proceed to step 340 in response to determining that there is no error. Further, the method may proceed to step 340 subsequent to recording the recoverable error at step 334. At step 340, a user database template is created and may include information such as, but not limited to, name, location, access parameters, and performance parameters. The user database template may be added to a user database. The user database template may be added to the anchor database. The user database template may be stored in a database for anchor data.

At step 342, an end user base configuration template may be created. Information common to all users may be added and may include, but is not limited to, a field for a user database template and user base directory names for user control space root directory, mobile messages, mobile pictures, videos, and audio, and computer emails and data. The user base configuration template may be stored in the user database. The user base configuration may also be stored in the anchor database.

At step 344, an end user subscription template may be created for a user to subscribe to services provided by the presently disclosed subject matter. An end user, such as a user of one of the computer 108, mobile device 110, and mobile device 112 shown in FIG. 1, may be provided with an interface, such as a website interface, for entering input into fields and making selections. Such inputs may include, but are not limited to, a name, address, telephone number, cell phone number, and an email ID. Various selections include, but are not limited to, a mobile device type, a computer type, and applications (e.g., archived and other applications offered by services disclosed herein). At step 344 shown in FIG. 3F, the subscription template may be stored in the anchor database and the user database.

At step 346, an error handler may be initiated. Subsequently, the error handler may determine whether an error has occurred (step 348). Example errors include, but are not limited to, cannot open database to store subscription template (permanent error), cannot write subscription template to database (permanent error). In response to determining that an error has occurred, it is determined whether the error is a recoverable error (step 350). In response to determining that the error is recoverable at step 350, the recoverable error may be recorded (step 352). On the other hand, in response to determining that the error is not recoverable, the error may be recorded as a permanent error at step 354 and the method may terminate at step 356. Subsequent to it being determined that there was no error at step 348 and recording at step 352, the method may end at step 358.

### Phase II—End User Subscription Template

Phase II may be integrated into Phase I. However, it may be implemented as a separate phase, because it is not order dependent, and it can be developed independent of the other phases. It may only be callable, and available at execution.

FIGS. 3A-3F, 4A and 4B, and 5A-5C illustrate flowcharts of example methods of end user subscription template implementation according to embodiments of the present disclosure. The end user can be provided with base functions (included with a subscription), and optional functions which are selectable by the end user. For example, capability to communicate messages and data is included, and applications may also be implemented. Base functions and optional functions selected by the end user can determine the set of functions that are provided in the user's single control space as disclosed in further detail herein below. In order for the presently disclosed subject matter to solve the stated problems and provide stated improvements, basic information may be collected from the end user. Basic end user subscription information is shown in FIG. 3 and described in further detail herein below.

The example method of FIGS. 4A-4B may be implemented by the server 102 shown in FIG. 1 or any other suitable server or electronic device. Referring to FIGS. 4A-4B, a subscribing end user invokes a subscription routine at a hosting server, such as the server 102 (step 400). For example, the end user may use an electronic device, such as the computer 108, to access the server 102 by a website via the network(s) 104. The website may provide a user interface for the end user to initiate a subscription, thereby invoking the subscription routine.

At step 402, a subscription template may be displayed to the end user and input may be collected. For example, the website may display the subscription template for collection of the input.

At step 404, it is determined whether a subscription fee is required. In response to determining that a subscription fee is required, the pending subscription may be saved and control passed to a billing system (step 406), which executes an independent process for billing the end user (step 408 shown in FIG. 4B). Subsequent to billing the end user, the pending subscription may be restored at step 410 shown in FIG. 4A.

In response to determining that a subscription fee is not required at step 404 or restoration of the pending subscription at step 410, the method may proceed to step 412 where a base user configuration template is retrieved from user database. Subsequent to step 412, an error handler may be initiated (step 414) and may determine whether an error has occurred (step 416). Example errors include, but are not limited to, the billing process was not successful (permanent error), the billing process request missing information—request missing information from user (recoverable error). In response to determining that an error has occurred, it is determined whether the error is a recoverable error (step 418). In response to determining that the error is recoverable at step 418, the recoverable error may be recorded (step 420). On the other hand, in response to determining that the error is not recoverable, the error may be recorded as a permanent error at step 422 and the method may terminate at step 424.

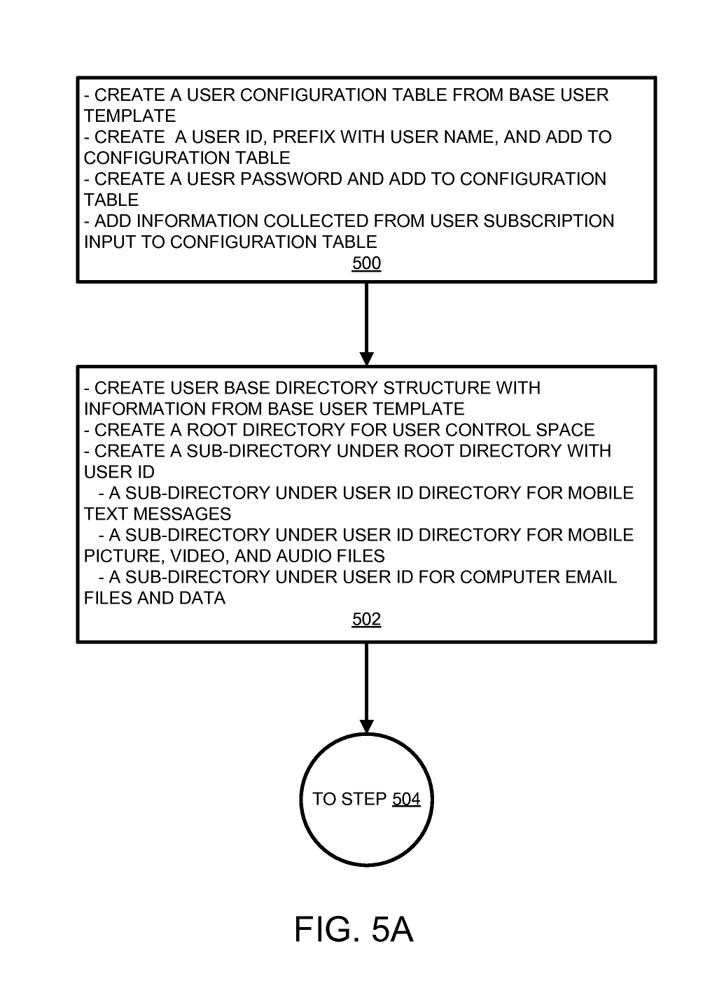

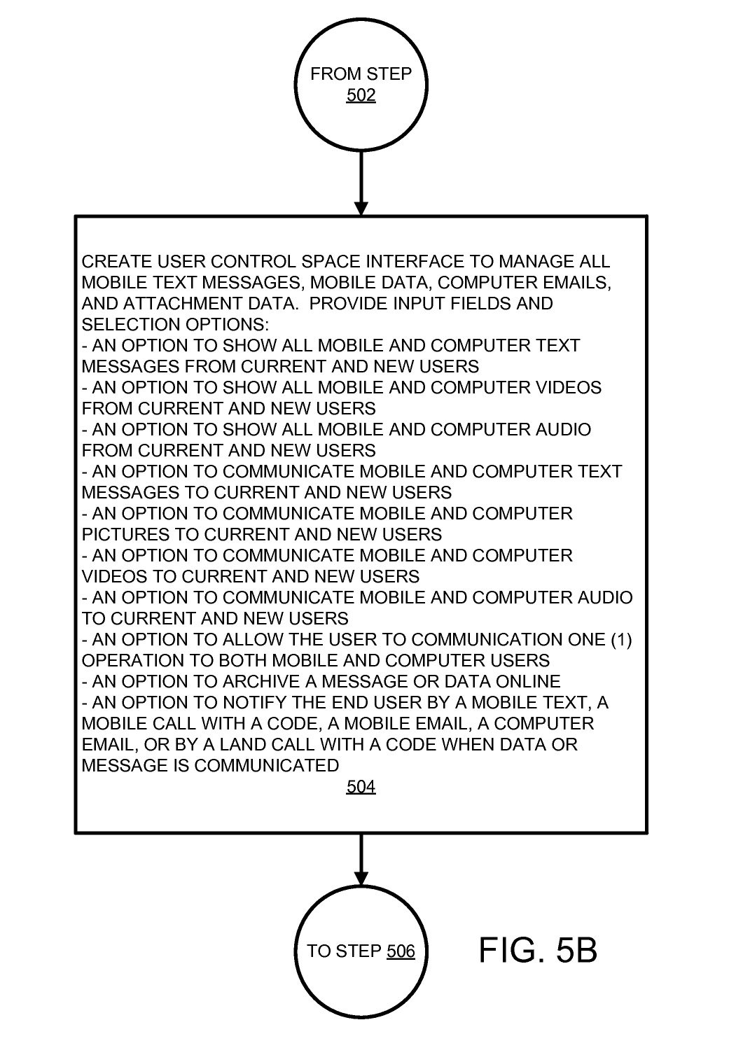

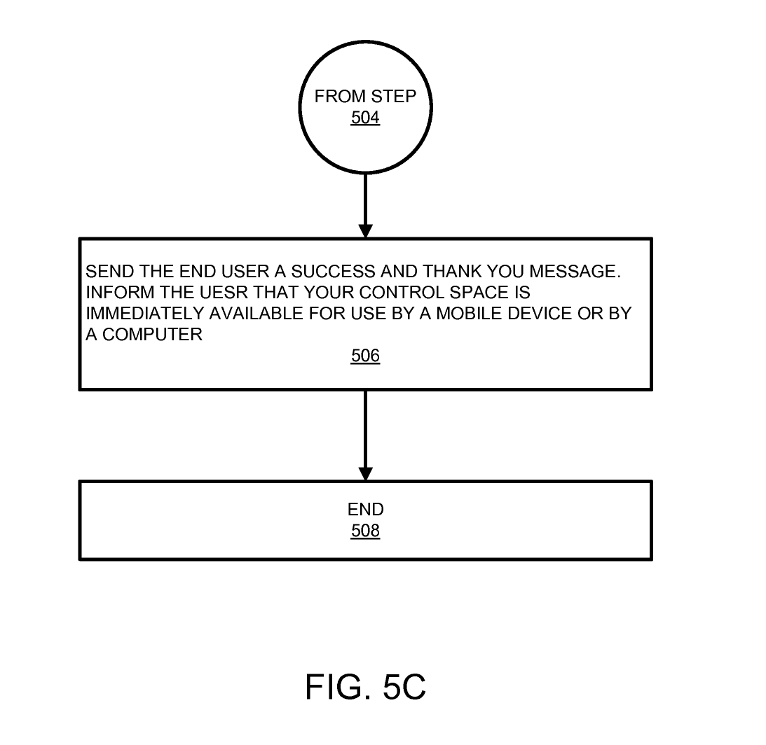

Subsequent to recording the error at step 420 or determining that there was no database error at step 416, the method may proceed to the method of FIGS. 5A-5C.

The method of FIGS. 5A-5C may be implemented by the server 102 or another suitable electronic device. Referring to FIGS. 5A-5C, a user configuration table may be created from a base user template at step 500. Further at step 500, a user ID and a prefix with a user name may be created, and added to a configuration table. Also, a user password may be created and added to the configuration table at step 500. Information may also be collected from user subscription input and added to the configuration table at step 500.

At step 502, a user base directory structure with information from the base user template may be created. Further, for example, a root directory may be created for user control space. In addition, a sub-directory may be created under the root directory with a user ID. Another sub-directory may be created under the user ID directory for mobile text messages. Another sub-directory may be created under the user ID directory for mobile pictures, video, and audio files. Yet another sub-directory may be created under the user ID for computer email files and data.

At step 504 shown in FIG. 5B, a user control space interface may be created for managing mobile text messages, mobile data, computer emails, and various other data, such as attachment data. Input fields and selection options may also be provided to the end user. For example, an option may be provided to show all mobile and computer text messages from current and new users having access in accordance with embodiments of the present disclosure. In another example, an option may be provided to show all mobile and computer pictures from current and new users having access in accordance with embodiments of the present disclosure. In another example, an option may be provided to show all mobile and computer videos from current and new users having access in accordance with embodiments of the present disclosure. In another example, an option may be provided to show all mobile and computer audio from current and new users having access in accordance with embodiments of the present disclosure. In another example, an option may be provided to communicate all mobile and computer text messages from current and new users having access in accordance with embodiments of the present disclosure. In another example, an option may be provided to communicate all mobile and computer pictures from current and new users having access in accordance with embodiments of the present disclosure. In another example, an option may be provided to communicate all mobile and computer videos from current and new users having access in accordance with embodiments of the present disclosure. In another example, an option may be provided to communicate all mobile and computer videos and audio from current and new users having access in accordance with embodiments of the present disclosure. Users may also invoke applications using any suitable electronic device. Messages and data may be archived online. End users may be notified of data or communications by a mobile text, a mobile call with a code, a mobile email, a computer email, by a land call with a code when data or a message is communicated.

At step 506, the end user may be sent a success and thank you message using a suitable technique. Further, the end user may be informed that his or her control space is immediately available for use by an electronic device, such as a mobile device or by a computer. Messages and data may be managed by type. An example benefit is that there is no need for attachments, an inbox, or folder types. As an example, when a user's control space is being used, processing and flow logic may continue. The method may subsequently end at step 508.

### Phase III—End User Single Control Space Template

Phase III may provide options and functions for the end user to manage and control mobile messages and mobile data (e.g., pictures, videos, and audio) that have been communicated to the user control space. Further, management and control may be provided for computer text and attachments that have been communicated to the user control space. The attachments may be resolved to data types (videos, images, audio, documents (e.g., pdf, EXCEL, HTML, and the like). The end user may not be presented with the concept of attachments in the control space. The end user may simply refer to messages by type and data by type. For example, the end user may display videos, images, audio, or simply communicate videos, images, audio, and text from and to the control space.

The end user is not required to do anything to identify message types or data types. All or at least some of the messages and data are self-identifying.

In an example operation, the end user can communicate text and data to mobile users and computer users. Mobile IDs and computer IDs can be in the same contact list.

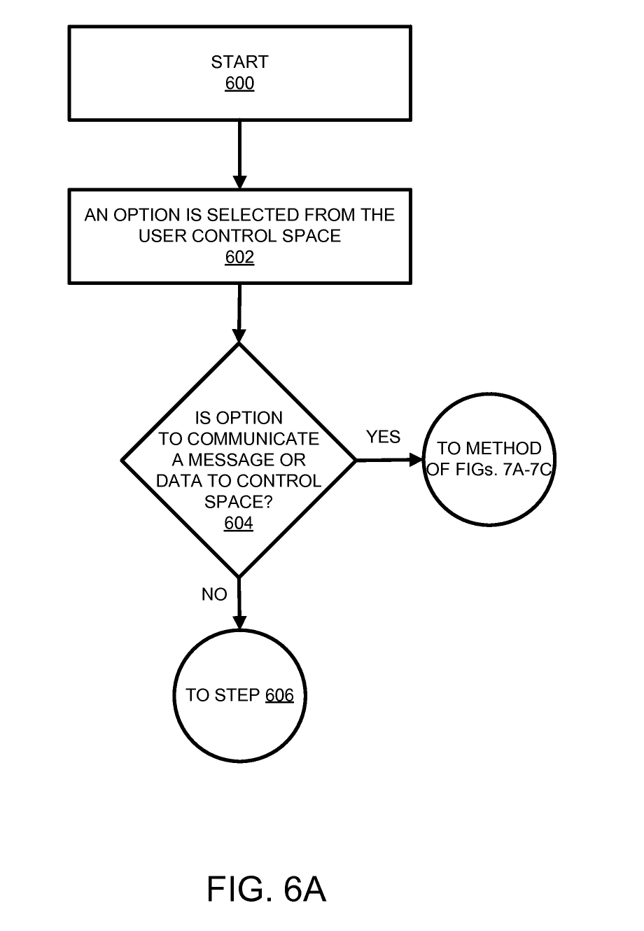

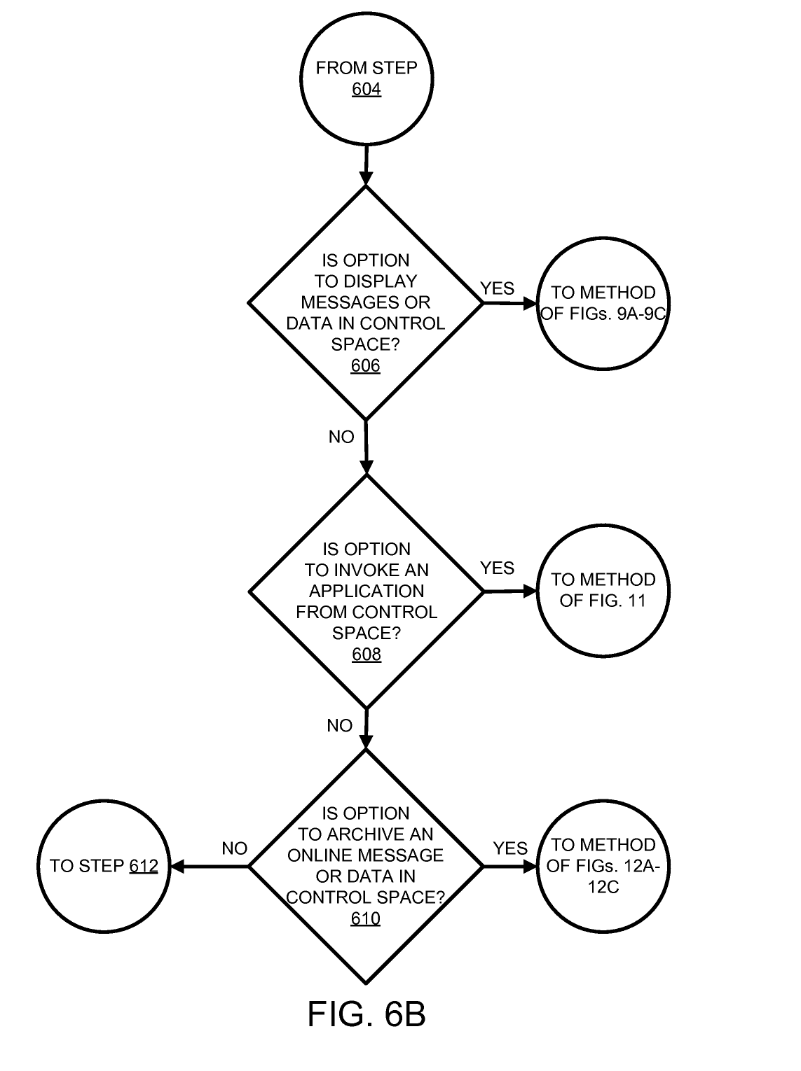

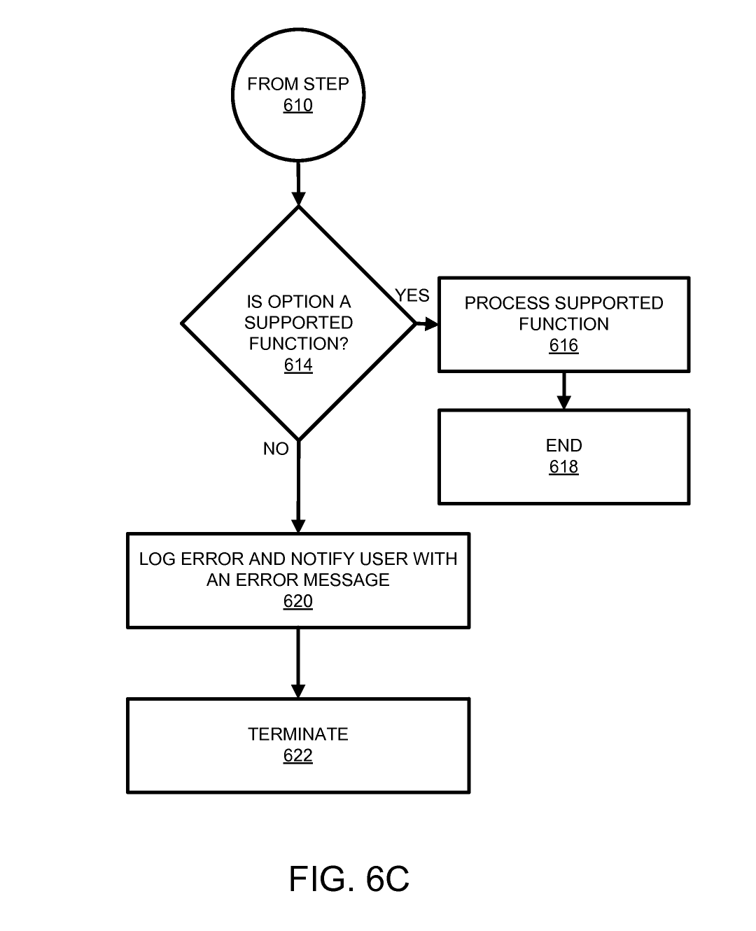

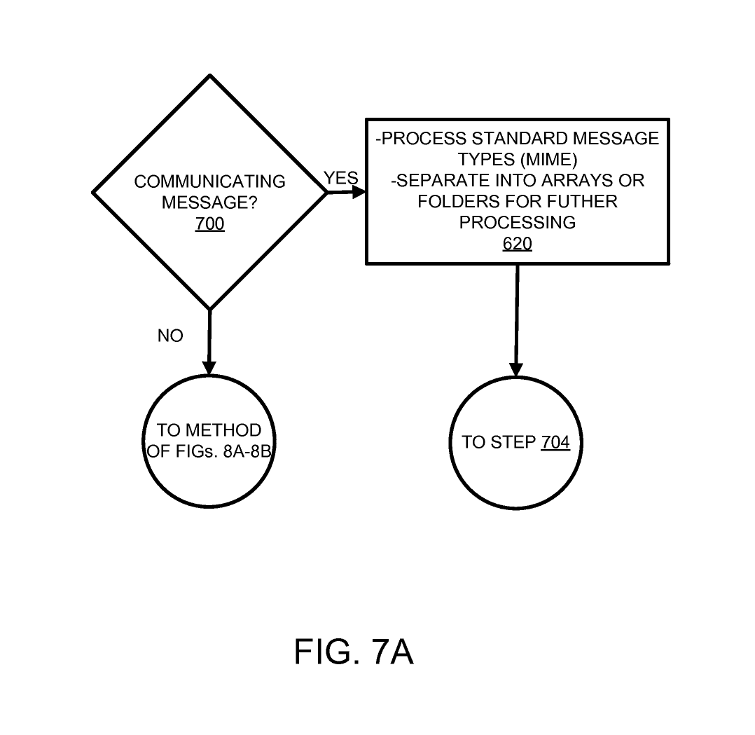

FIG. 6A-6C illustrates a flowchart of an example method for controlling data communications according to embodiments of the present disclosure. The method may be implemented by the server 102 shown in FIG. 1 or any suitable electronic device. Referring to FIGS. 6A-6C, the method may start at step 600 and option may be selected from a user control space at step 602. For example, an end user using an electronic device, such as the computer 108, may access a website administered by the server 102 for selecting the option.

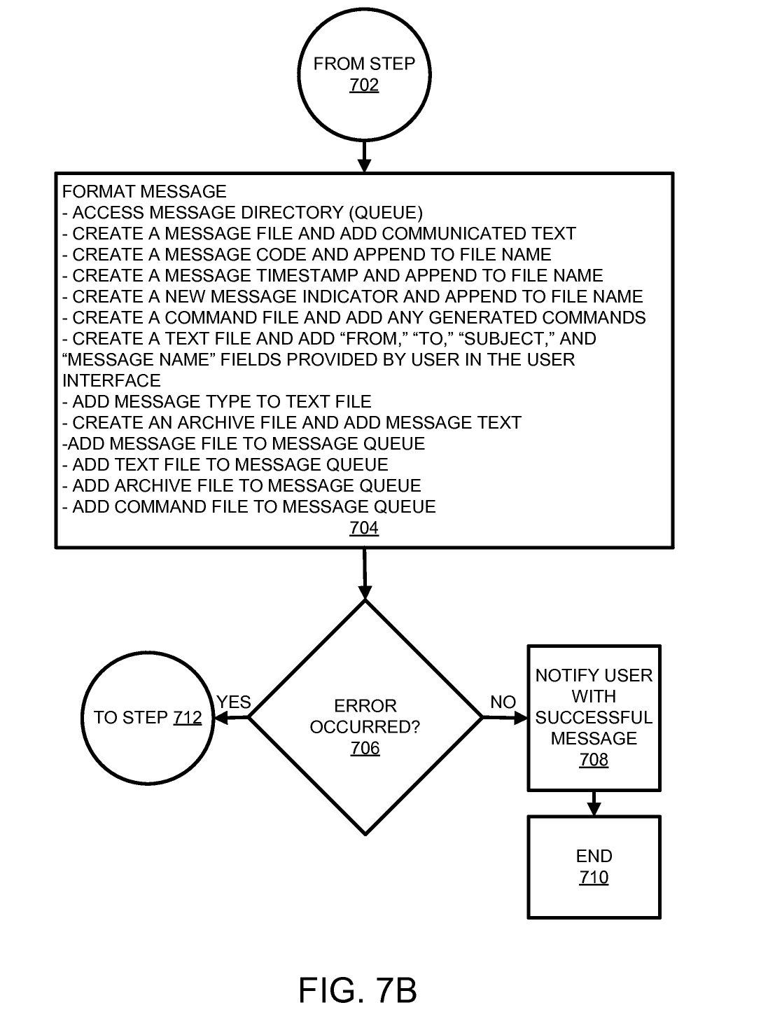

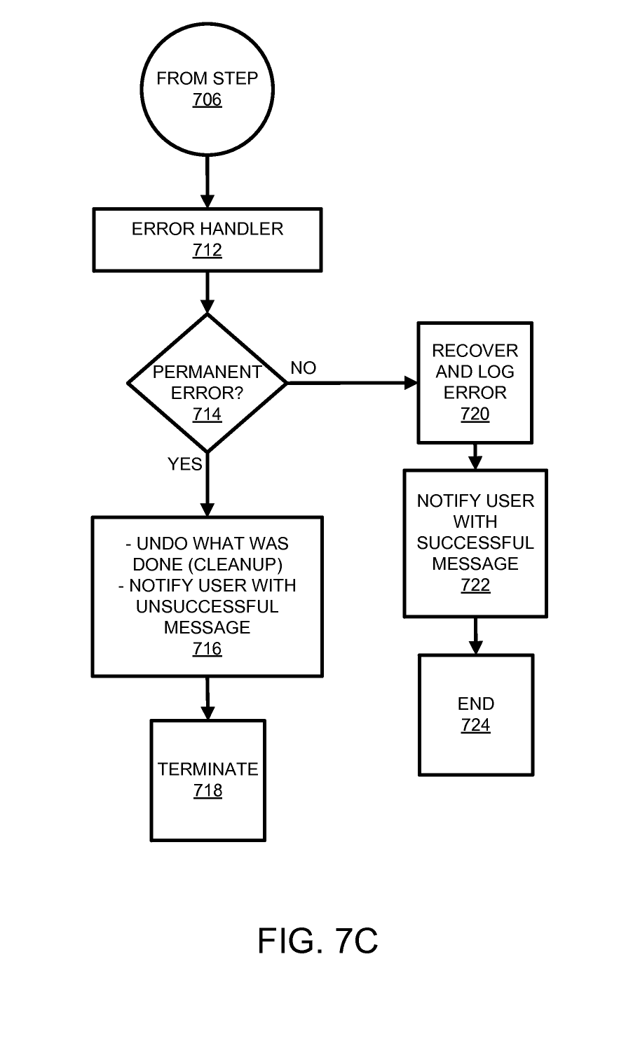

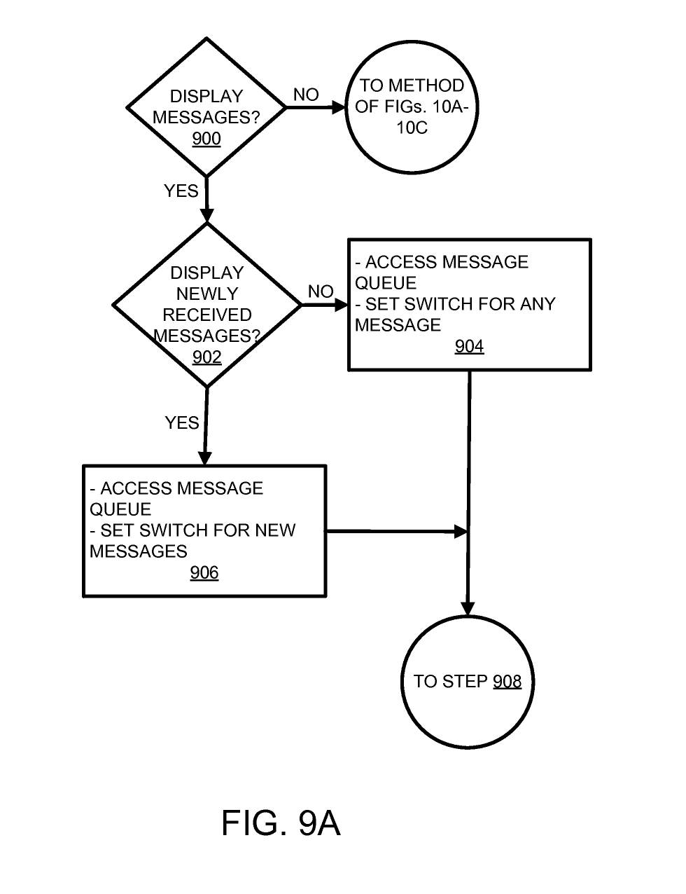

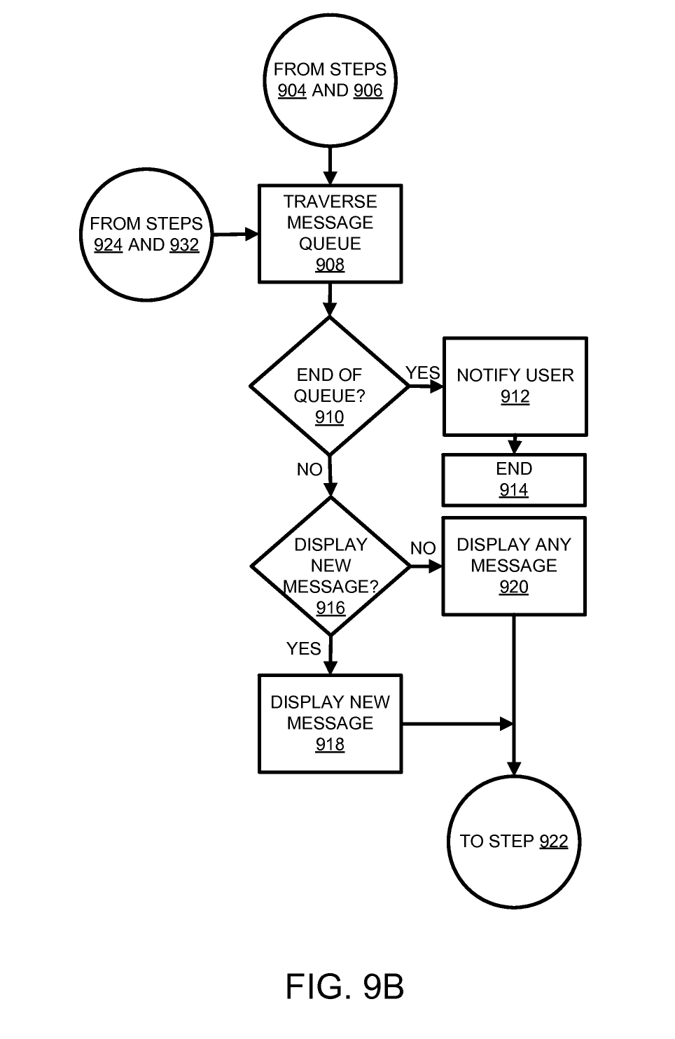

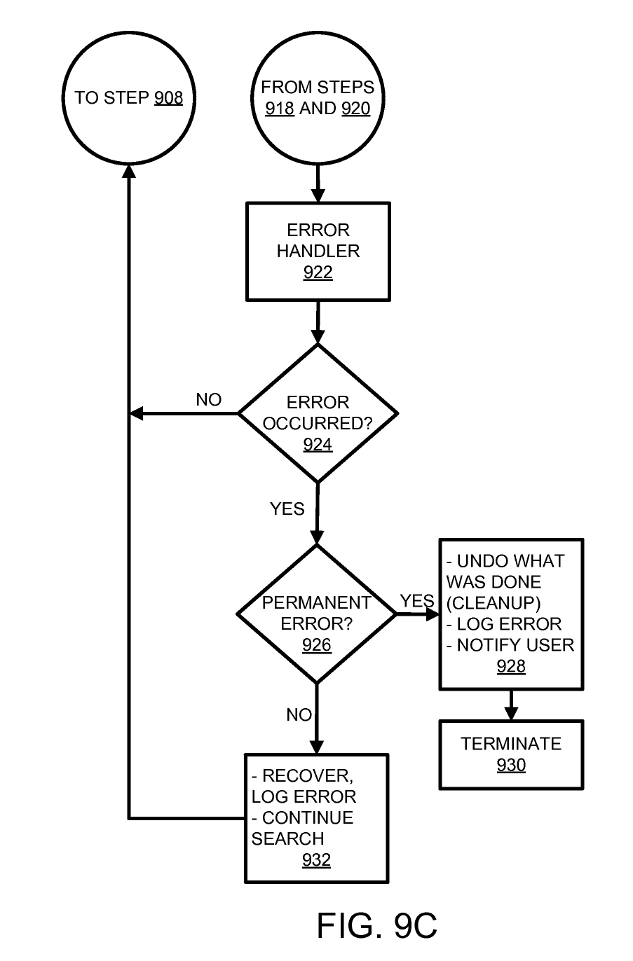

At step 604, it is determined whether the selected option is for communicating a message or data to the control space of the user. In response to determining that the selected option is for communicating a message or data to the control space, the method may end and operations proceed to the method of FIGS. 7A-7C for phase IV described below. In response to determining that the selected option is not for communicating a message or data to the control space, the method may proceed to step 606 where it is determined whether the option is to display messages or data in the control space (step 606). In response to determining that the option is to display messages or data in the control space, the method may end and operations proceed to the method of FIGS. 9A-9C for phase IV described below. In response to determining that the option is not to display messages or data in the control space, the method may proceed to step 608.

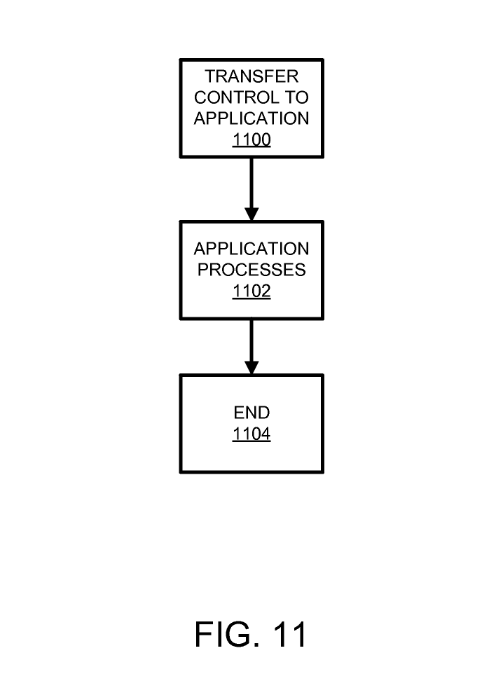

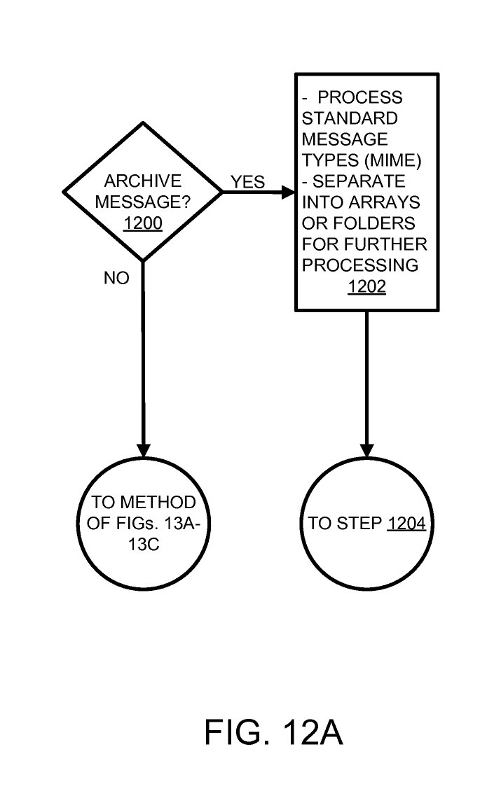

At step 608, it is determined whether the option is to invoke an application from the control space. In response to determining that the option is to invoke an application from the control space, the method may end and operations proceed to the method of FIG. 11 for phase V described below. In response to determining that the option is to not invoke an application from the control space, the method may proceed to step 610.

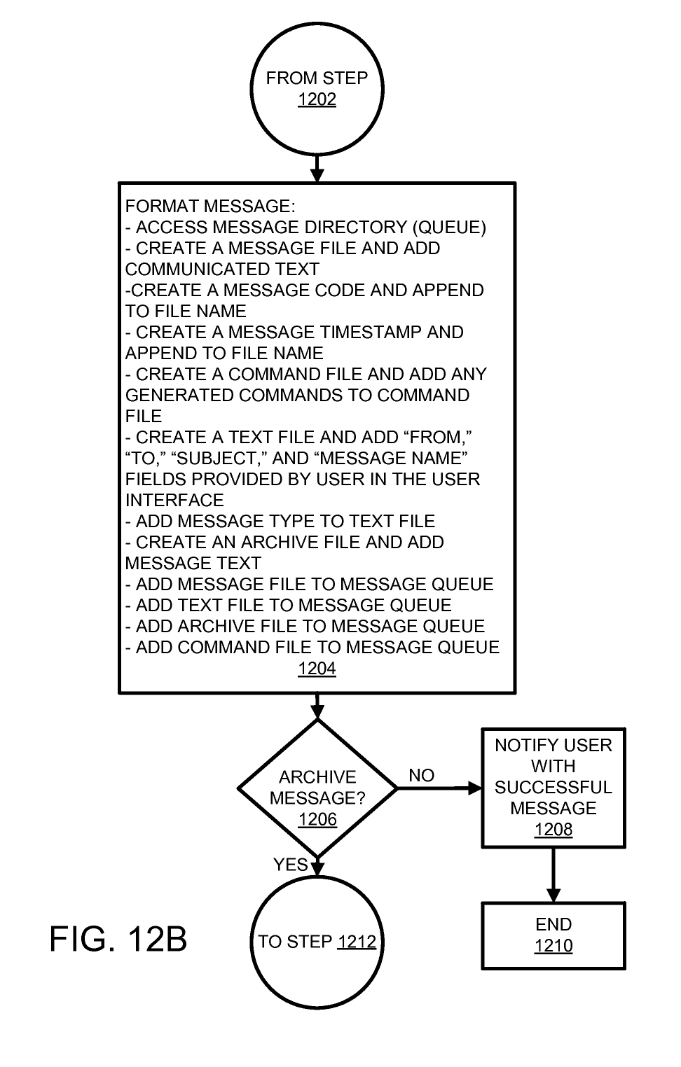

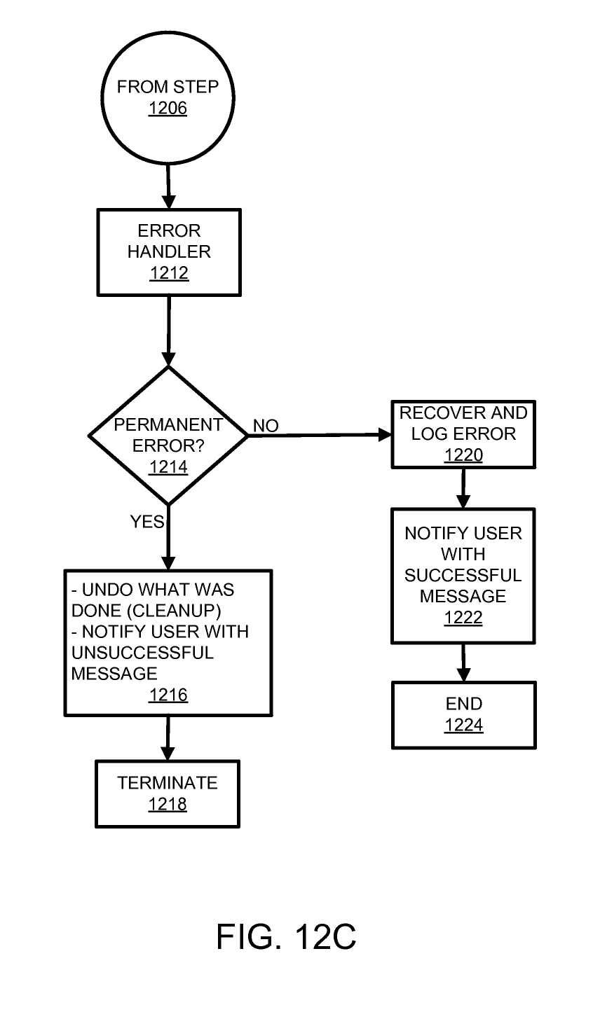

At step 610, it is determined whether the option is to archive an online message or data in the control space. In response to determining that the option is to archive an online message or data in the control space, the method may end and operations proceed to the method of FIGS. 12a-12C for phase V described below. In response to determining that the option is not to archive an online message or data in the control space, the method may proceed to step 614.

At step 614, it is determined whether the option is a supported function. In response to determining that the option is a supported function, the process supported function may be implemented (step 616) and the method may end (step 618). In response to determining that the option is not a supported function, the error may be logged and the end user notified with an error message (step 620) and the method may end (step 622).

### Phase IV—End User Single Control Space Options

In phase IV, options may be provided for end users to communicate messages and data to and from the user's control space using an electronic device such as, but not limited to, mobile device or a computer. Examples of these functions are made by reference to the methods of FIGS. 7A-7C, FIGS. 8A-8B, FIGS. 9A-9C, and FIGS. 10A-10C. Also, options are provided by the system and method embodiments disclosed herein for a user to display messages by types and data by types. These example methods may be implemented by the server 102 shown in FIG. 1 or another suitable electronic device.

End user devices can be enabled to display only new messages and data, all messages and data, or a specific message type or data type in accordance with embodiments of the present disclosure. The options for this method are open ended without limitations. The options that are listed in the flowcharts are may be used to implement these functions and others disclosed herein.

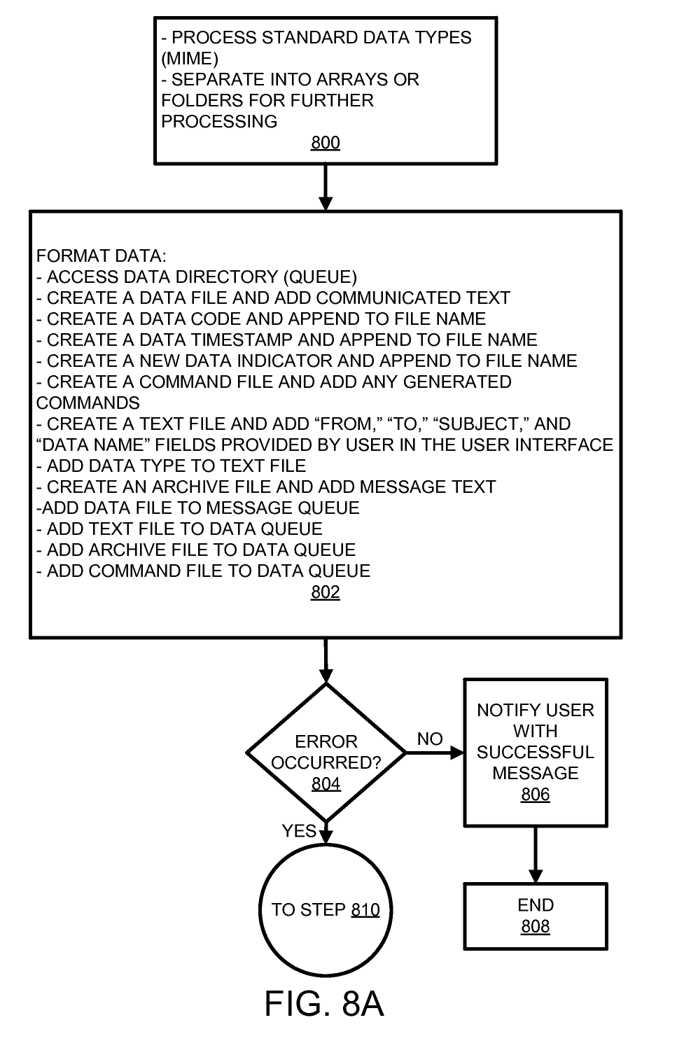

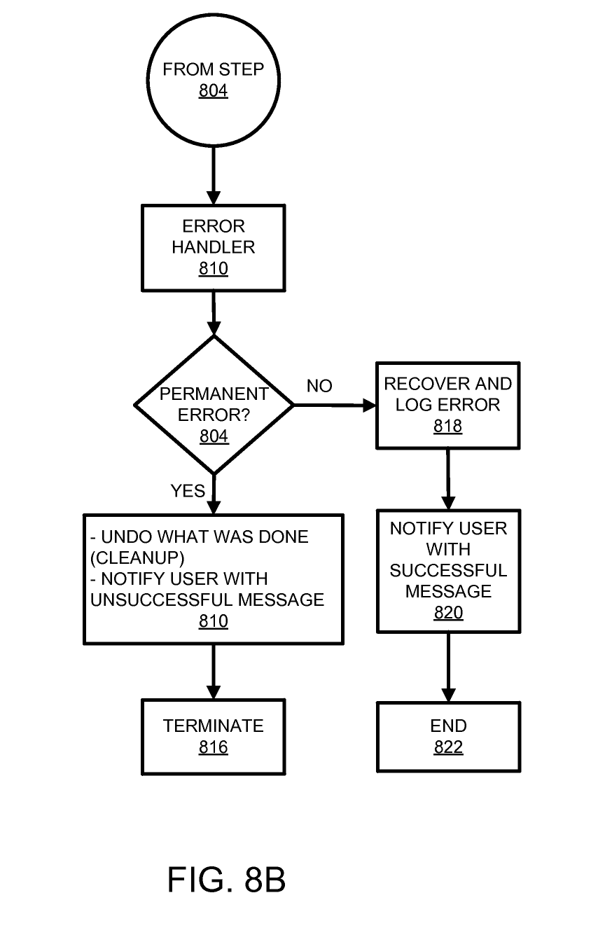

Referring now to FIGS. 7A-7C, the method includes determining whether a message is to be communicated (step 700). The message may have been received by any suitable technique from a remote electronic device. In response to determining that a message is to be communicated, the message may be processed in accordance with standard message types (step 702). For example, the type may be multi-purpose Internet mail extensions (MIME), which is an Internet standard for text, attachments, and headers in 7 and 8-bit character sets. MIME may be used in accordance with the present disclosure to provide migration for current users of mobile and computer messages and emails. Subsequently, the method may proceed to step 704 of FIG. 7B. In response to determining that a message is not to be communicated, the method may stop and operations may proceed to the method of FIGS. 8A-8B.

At step 704, the message may be formatted. A message directory (queue) may be accessed. A message file may be created and communicated text added. A message code may be created and a file name appended. A message timestamp may be created and appended to the file name. A new message indicator may be created and appended to the file name. A command file may be created and any generated commands may be added to the command file. Further, a text file may be created and a “From,” “To,” “Subject,” and “Message Name” fields provided by the user in the user interface. A message type may be added to the text file. An archive file may be created and message text added. A message file may be added to the message queue. A text file may be added to the message queue. An archive file may be added to the message queue. A command file may be added to the message queue.

At step 706, it is determined whether an error occurred. In response to determining that an error has not occurred, a user is notified that the message was successful (step 708) and the method ends (step 710). In response to determining that an error has occurred, an error handler is initiated (step 712) and determines whether the error is permanent (step 714). In response to determining that the error is permanent, an undo is implemented and the user is notified of the unsuccessful message (step 716) and the method terminates (step 718).

In response to determining that the error is not permanent at step 714, the system recovers and the error is logged (step 720). Subsequently, the user is notified with a successful message (step 722) and the method ends (step 724).

Referring to FIGS. 8A-8B, standard data types may be processed and separated into arrays or folders for further processing (step 800). At step 802, the data may be formatted. An access data directory (queue) may be accessed. A data file may be created and communicated text added. A data code may be created and a file name appended. A data timestamp may be created and appended to the file name. A new data indicator may be created and appended to the file name. A command file may be created and any generated commands may be added to the command file. Further, a text file may be created and a “From,” “To,” “Subject,” and “Data Name” fields provided by the user in the user interface. A data type may be added to the text file. An archive file may be created and message text added. A data file may be added to the data queue. A text file may be added to the data queue. An archive file may be added to the data queue. A command file may be added to the data queue.

At step 804, it is determined whether an error occurred. In response to determining that an error has not occurred, a user is notified that the message was successful (step 806) and the method ends (step 808). In response to determining that an error has occurred, an error handler is initiated (step 810) and determines whether the error is permanent (step 812). In response to determining that the error is permanent, an undo is implemented and the user is notified of the unsuccessful message (step 814) and the method terminates (step 816).

In response to determining that the error is not permanent at step 814, the system recovers and the error is logged (step 818). Subsequently, the user is notified with a successful message (step 820) and the method ends (step 822).

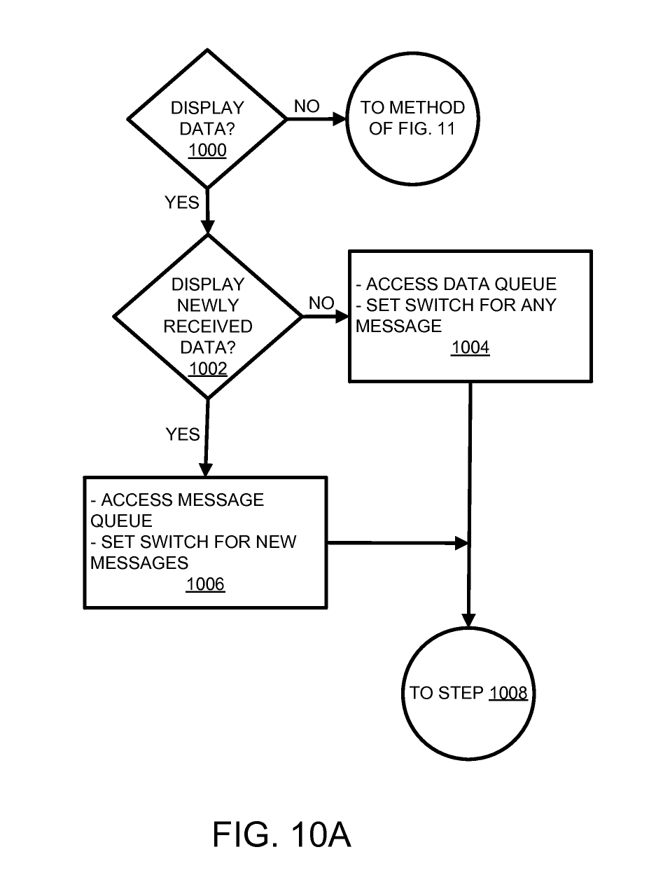

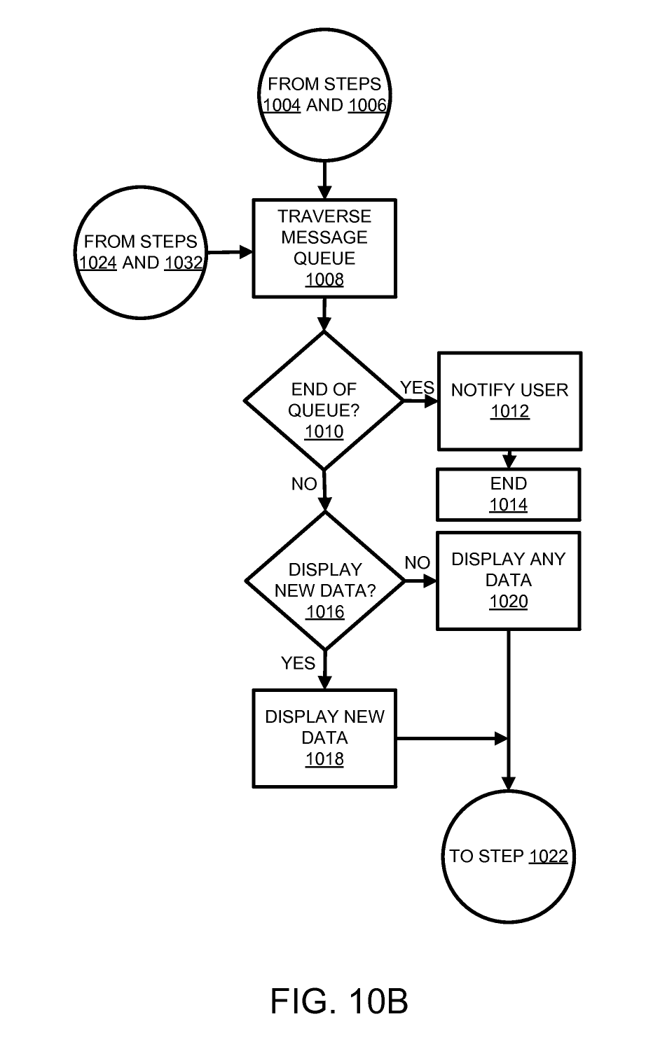

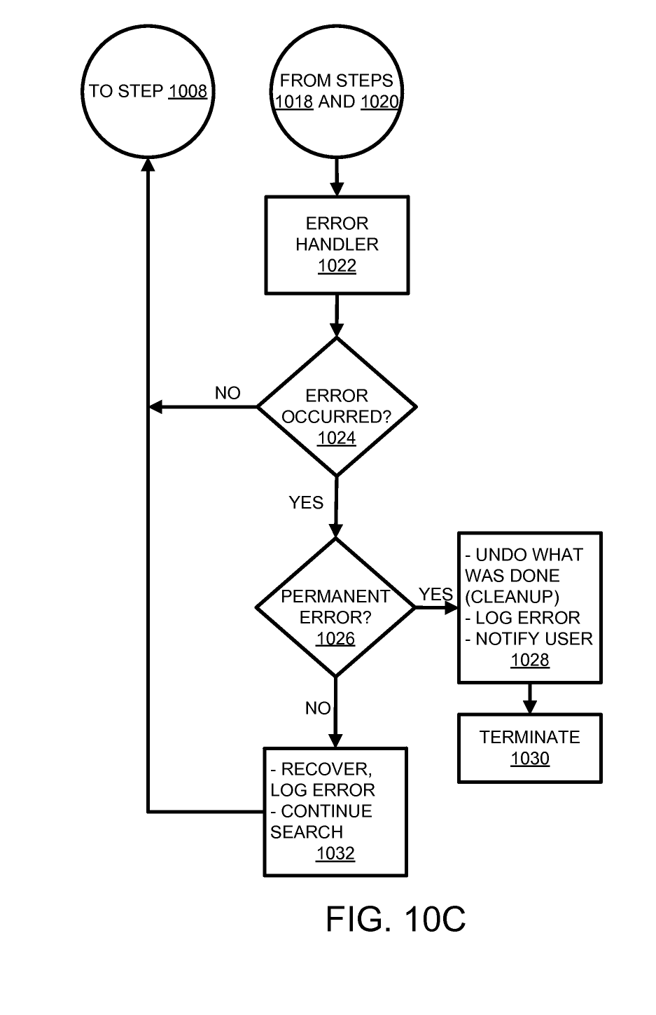

Now referring to FIGS. 9A-9C, it is determined whether to display messages (step 900). In response to determining not to display messages, the method of FIGS. 9A-9C stops and the method of FIGS. 10A-10C is implemented. In response to determining to display messages, it is determined whether to display newly received messages (step 902). In response to determining not to display newly received messages, the message queue may be accessed and a switch set for any message (step 904). In response to determining to display newly received messages, the message queue may be accessed and a switch set for new messages (step 906).

Subsequent to steps 904 and 906, the message queue is traversed (step 908). Subsequently, it is determined whether the end of the queue is reached (step 910). In response to determining that the end of the queue is reached, the user may be notified (step 912) and the method ends (step 914). In response to determining that the end of the queue is not reached, it is determined whether to display a new message (step 916). In response to determining to display a new message, the new message is displayed (step 918). In response to determining not to display a new message, any message is displayed (step 920).

Subsequent to steps 918 and 920, an error handler is initiated (step 922) and it is determined whether an error occurred (step 924). In response to determining that an error has not occurred, the method proceeds to step 908. In response to determining that an error has occurred, it is determined whether the error is permanent (step 926). In response to determining that the error is permanent, an undo is implemented, the error logged, and the user is notified of the unsuccessful message (step 928) and the method terminates (step 930).

In response to determining that the error is not permanent at step 926, the system recovers, the error is logged, and the search continued (step 932). Subsequently, the method proceeds to step 908.

Referring to FIGS. 10A-10C, it is determined whether to display data (step 1000). In response to determining not to display data, the method ends and the method of FIG. 11 is implemented. In response to determining to display data, it is determined whether to display the newly received data (step 1002). In response to determining not to display newly received data, the data queue may be accessed and a switch set for any message (step 1004). In response to determining to display newly received data, the data queue may be accessed and a switch set for new messages (step 906).

Subsequent to steps 1004 and 1006, the message queue is traversed (step 1008). Subsequently, it is determined whether the end of the queue is reached (step 1010). In response to determining that the end of the queue is reached, the user may be notified (step 1012) and the method ends (step 1014). In response to determining that the end of the queue is not reached, it is determined whether to display new data (step 1016). In response to determining to display new data, the new data is displayed (step 1018). In response to determining not to display new data, any data is displayed (step 1020).

Subsequent to steps 1018 and 1020, an error handler is initiated (step 1022) and it is determined whether an error occurred (step 1024). In response to determining that an error has not occurred, the method proceeds to step 1008. In response to determining that an error has occurred, it is determined whether the error is permanent (step 1026). In response to determining that the error is permanent, an undo is implemented, the error logged, and the user is notified of the unsuccessful message (step 1028) and the method terminates (step 1030).

In response to determining that the error is not permanent at step 1026, the system recovers, the error is logged, and the search continued (step 1032). Subsequently, the method proceeds to step 1008.

### Phase V—Applications

Phase V provides options to end users to invoke applications selected during the subscription phase. Examples of these features are described with respect to FIG. 3 and Phase II. The applications may execute as an independent process and provide functions unique to the application. The applications may execute in an environment according to the present disclosure, and utilize process resources as described herein. This phase may be considered optional.

FIG. 11 illustrates a flowchart of an example method for implementing applications in accordance with embodiments of the present disclosure. Referring to FIG. 11, control is transferred to an application (step 1100). Applications may execute as independent processes. Subsequently, application processes are implemented (step 1102) and the method ends (step 1104)

### Phase VI—Online Archive

Phase VI provides an end user with an option to instantly or quickly archive any of various message or data type online. This feature may allow the end user to keep the list of messages and data at a management level on a day-to-day basis.

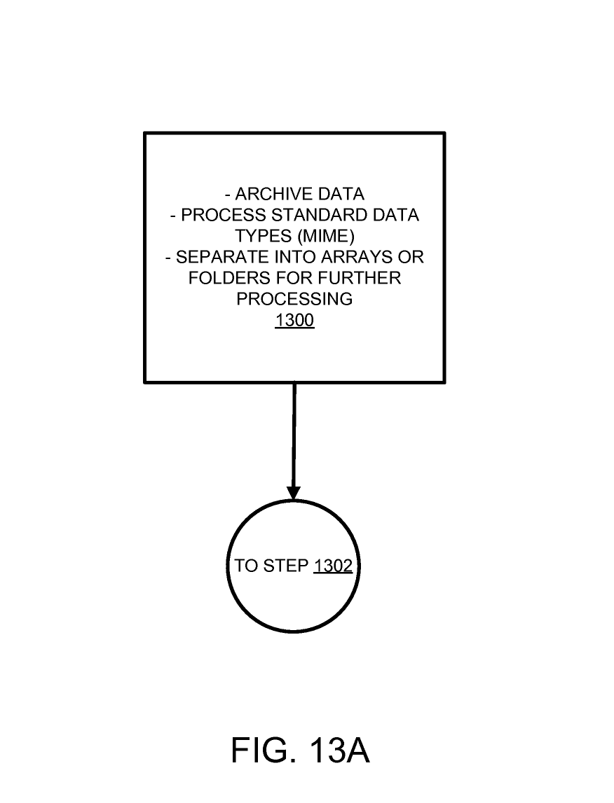

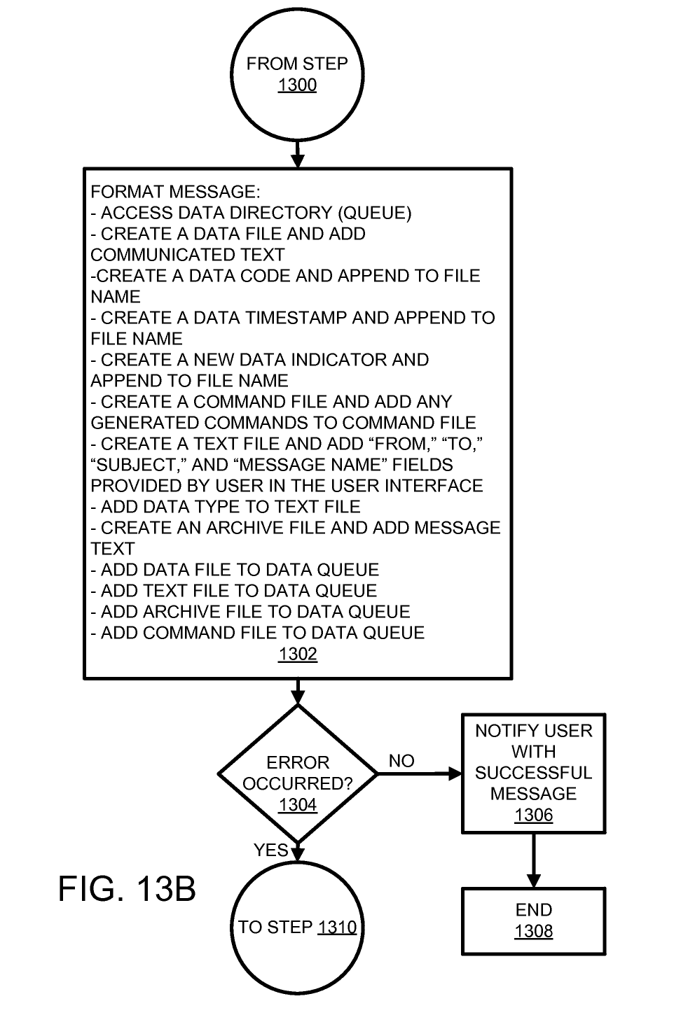

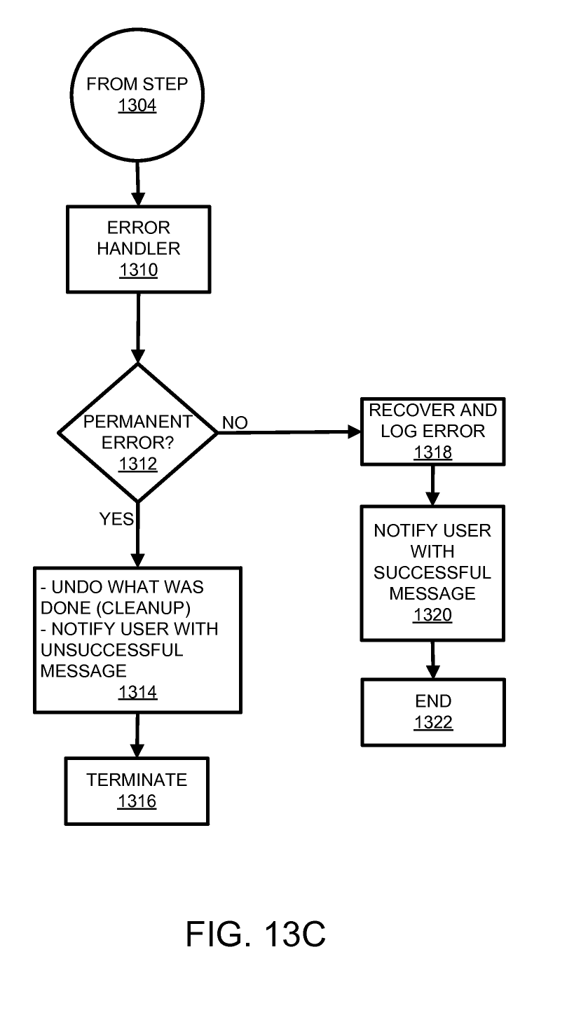

An example method according to the present disclosure may use the same structure for the archived messages and data as none archived messages and data. This technique and strategy may allow the end user to view seamless archived messages and data with none archived messages and data. These features are shown in FIG. 12 and FIG. 13.

FIG. 12A-12C illustrate a flowchart of an example method according to embodiments of the present disclosure. Referring to FIGS. 12A-12C, it is determined whether to archive a message (step 1200). In response to determining not to archive a message, the method may end and the method of FIGS. 13A-13C implemented. In response to determining to archive a message, the message may be processed and separated into arrays or folders for further processing (step 1202).

Subsequently at step 1204, the message may be formatted. A message directory (queue) may be accessed. A message file may be created and communicated text added. A message code may be created and a file name appended. A message timestamp may be created and appended to the file name. A new data indicator may be created and appended to the file name. A command file may be created and any generated commands may be added to the command file. Further, a text file may be created and a “From,” “To,” “Subject,” and “Data Name” fields provided by the user in the user interface. A message type may be added to the text file. An archive file may be created and message text added. A message file may be added to the message queue. An archive file may be added to the message queue. An archive file may be added to the message queue. A command file may be added to the message queue.

At step 1206, it is determined whether an error occurred. In response to determining that an error has not occurred, a user is notified that the message was successful (step 1208) and the method ends (step 1210). In response to determining that an error has occurred, an error handler is initiated (step 1212) and determines whether the error is permanent (step 1214). In response to determining that the error is permanent, an undo is implemented and the user is notified of the unsuccessful message (step 1216) and the method terminates (step 1218).

In response to determining that the error is not permanent at step 1214, the system recovers and the error is logged (step 1220). Subsequently, the user is notified with a successful message (step 1222) and the method ends (step 1224).

FIG. 13A-13C illustrate a flowchart of an example method according to embodiments of the present disclosure. Referring to FIGS. 13A-13C, data is archived and stored into arrays or folders for further processing (step 1300). At step 1302, the data may be formatted. A data directory (queue) may be accessed. A data file may be created and communicated text added. A data code may be created and a file name appended. A data timestamp may be created and appended to the file name. A new data indicator may be created and appended to the file name. A command file may be created and any generated commands may be added to the command file. Further, a text file may be created and a “From,” “To,” “Subject,” and “Data Name” fields provided by the user in the user interface. A data type may be added to the text file. A text file may be created and message text added. A message file may be added to the data queue. An archive file may be added to the data queue. An archive file may be added to the data queue. A command file may be added to the data queue.

At step 1304, it is determined whether an error occurred. In response to determining that an error has not occurred, a user is notified that the message was successful (step 1306) and the method ends (step 1308). In response to determining that an error has occurred, an error handler is initiated (step 1310) and determines whether the error is permanent (step 1312). In response to determining that the error is permanent, an undo is implemented and the user is notified of the unsuccessful message (step 1314) and the method terminates (step 1316).

In response to determining that the error is not permanent at step 1312, the system recovers and the error is logged (step 1318). Subsequently, the user is notified with a successful message (step 1320) and the method ends (step 1322).

### Phase VII—Error Handling

Phase VII is necessary and can be used by all phases. The types of errors for a method according to the present disclosure are not limited to what is shown in the flowcharts. In general, the errors can be handled by one error handler, which can be used by all phases. These features are shown in FIG. 3. If the error handler recovers from the error, processing may continue. If not, processing may terminate.

### Phase VIII—Recipient Notifications

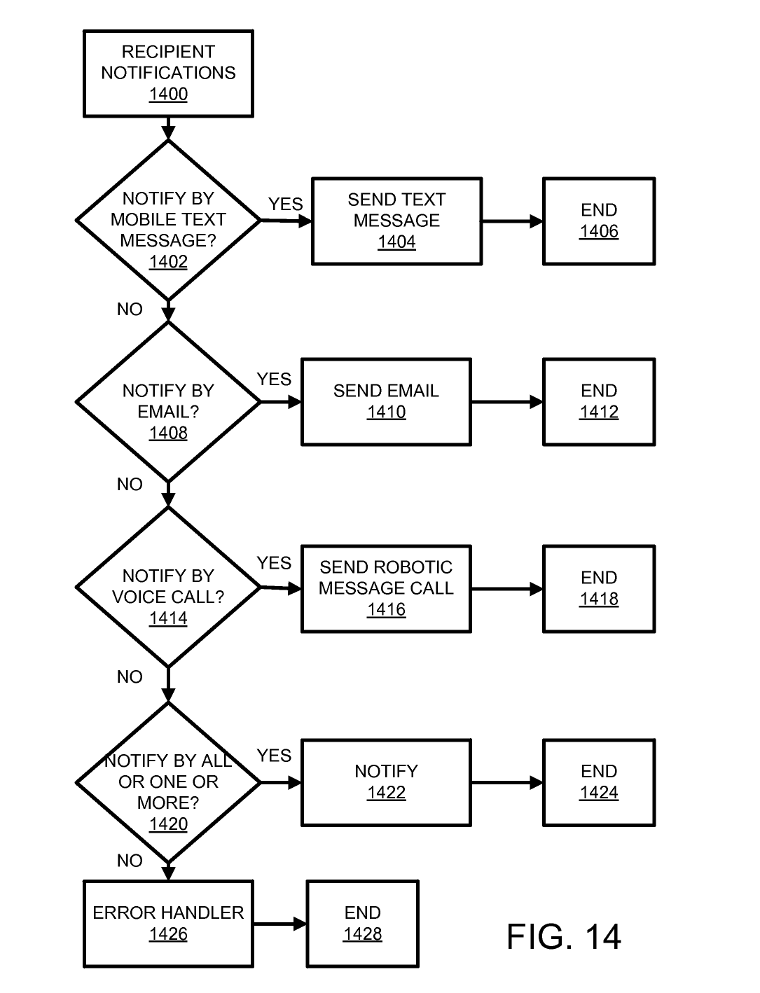

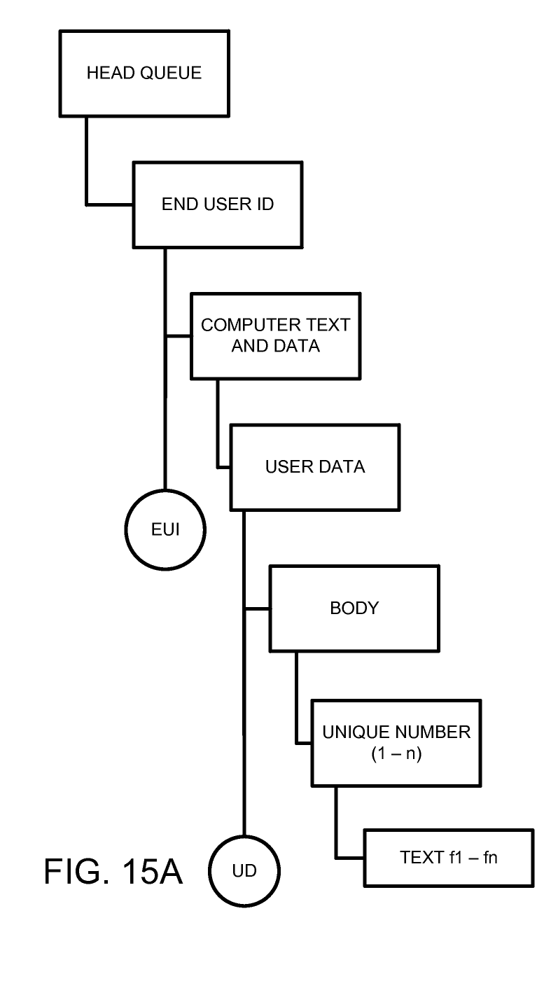

In phase VIII, an end user may be provided with an option to notify recipients. Recipients can be notified by a mobile text message, an email, or by a robotic call. All, one, or more can be selected by the end user. This feature is shown in FIG. 14, which illustrates a flow chart of another example method according to embodiments of the present disclosure.

Referring to FIG. 14, a recipient notifications process may be initiated (step 1400). At step 1402, it is determined whether to notify by a mobile text message. In response to determining to notify by a mobile text message, a text message is sent (step 1404) and the method ends (step 1406). Otherwise, the method proceeds to step 1408.

At step 1408, it is determined whether to notify by email. In response to determining to notify by an email, an email is sent (step 1410) and the method ends (step 1412). Otherwise, the method proceeds to step 1414.

At step 1414, it is determined whether to notify by voice call. In response to determining to notify by a voice call, a robotic message call is sent (step 1416) and the method ends (step 1418). Otherwise, the method proceeds to step 1420.

At step 1420, it is determined whether to notify by all or one or more. In response to determining to notify by all or one or more, all or one or more of these techniques are used for sending the notification (step 1422) and the method ends (step 1424). Otherwise, an error handler is initiated at step 1426 and the method ends at step 1428.

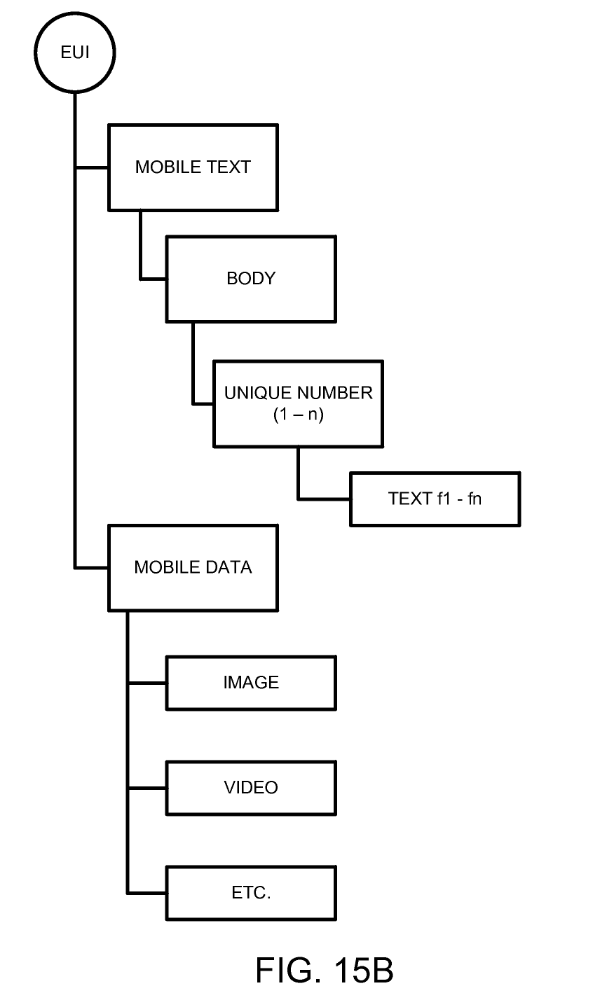

FIG. 15 illustrates a file diagram of a message and data queue in accordance with embodiments of the present disclosure.

### Example Screen Displays

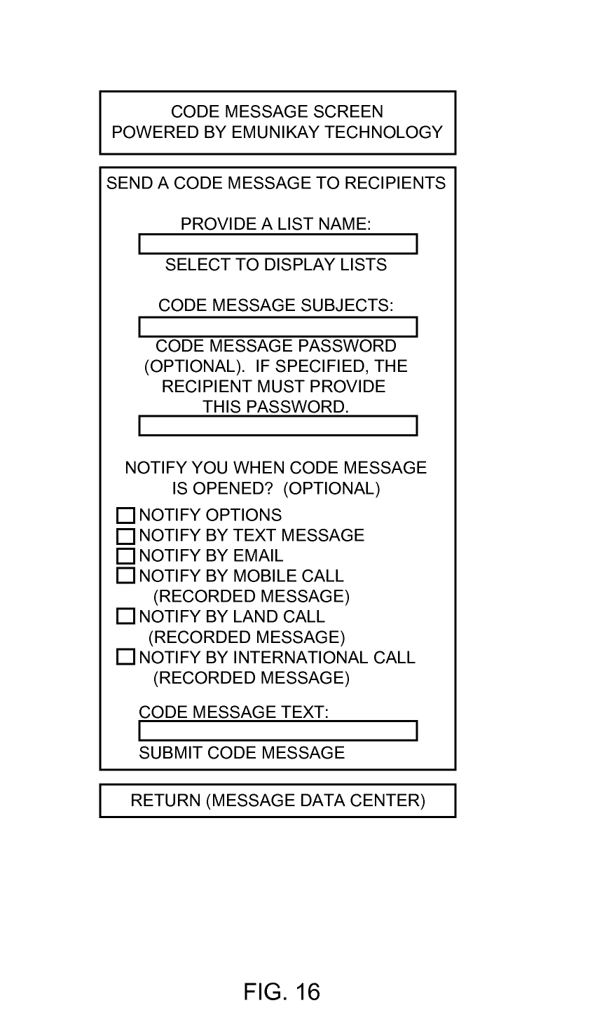

FIGS. 16-20 illustrate various example screen displays presented to an end user of an electronic device accessing a server in accordance with embodiments of the present disclosure. For example, an end user may use an electronic device, such as the computer 108, for accessing the server 102, which provides a website for presenting these example screen displays. Referring to FIG. 16, the end user may interact with this screen display for communicating a code message to one or more recipients. The end user may enter a list name that identifies one or more recipients for receipt of the code message. In addition, the end user may enter a code message subject and a code message password. The end user may also enter various notification methods (e.g., text message, email, mobile call, land call, and/or international call. The end user may also enter text for describing use of the code message. Information for a contact message may be similarly entered in a screen display.

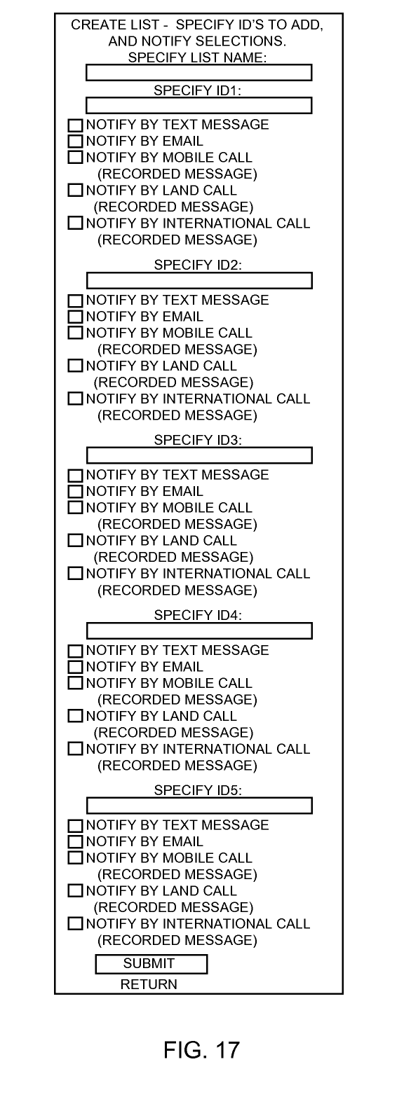

Referring to FIG. 17, the end user may enter identifiers of users for addition to a list of recipients. In addition, the end user may enter a notification method for each identified user.

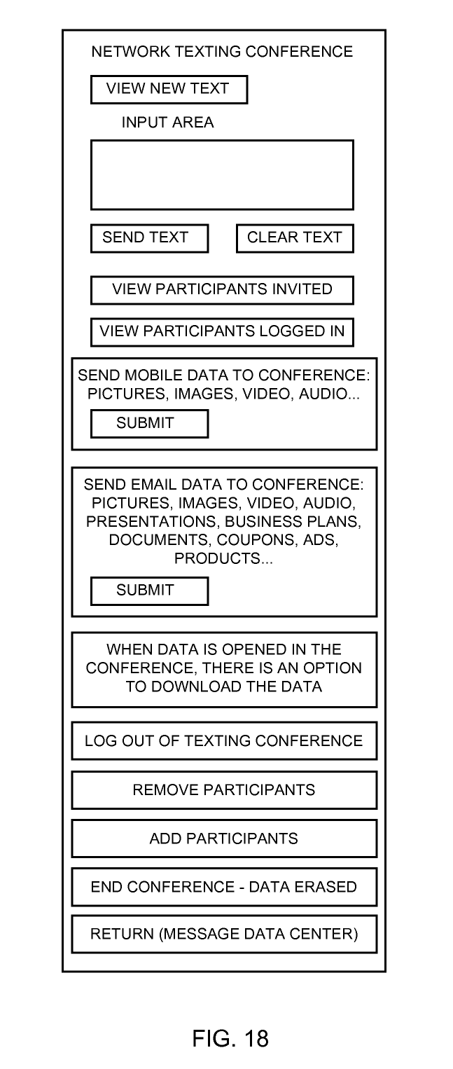

Referring to FIG. 18, the screen display provides an input area for the end user to enter text for communicating to identified recipients. Further, the end user may select one or more data (e.g., images, video, audio, and the like) for communicating to recipients. The end user may also make selections for logging out of the conference, removing participants, adding participants, and ending the conference.

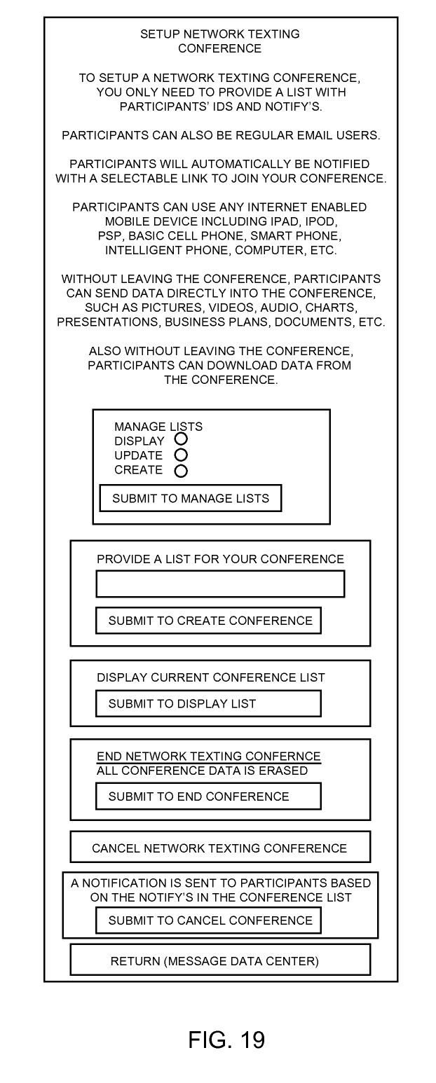

Referring to FIG. 19, this display screen may be used for setting up a network texting conference. The end user may make a selection for displaying, updating, or creating a list. The end user may also display a current conference list, end a network texting conference list, or cancel a network texting conference.

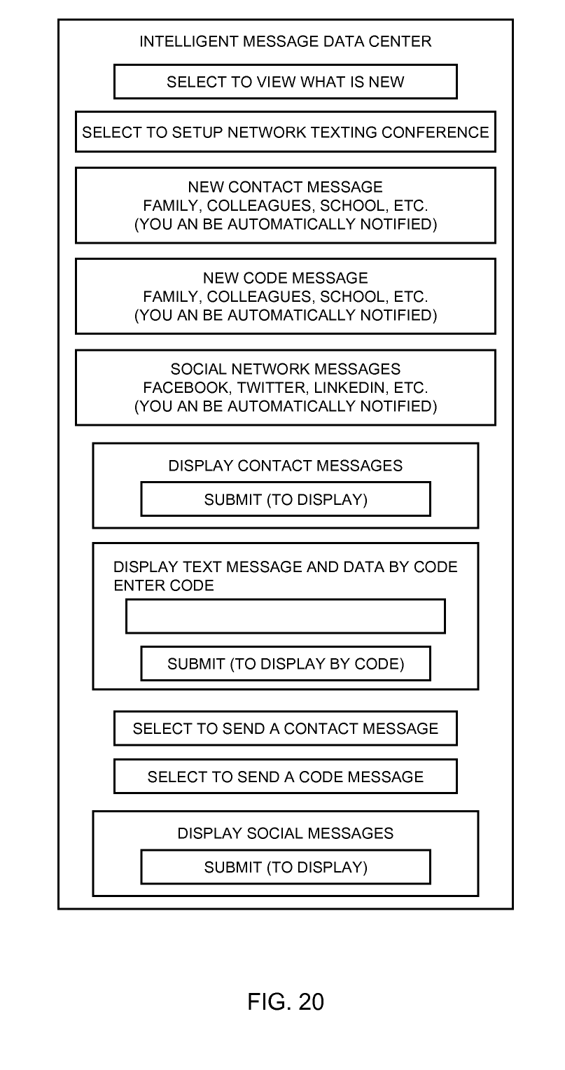

Referring to FIG. 20, this display screen may be used for selecting setup of a network texting conference, sending a new contact message, sending a new code message, sending social network messages, displaying contact messages, displaying text messages and data by code, selecting to send a contact message, selecting to send a code message, and displaying social message.

### Various Example Features

In accordance with embodiments of the present disclosure, a code message may be used for allowing a user to enter a control space of another user. For example, a user may use an electronic device for accessing a website administered by the server 102 and for inputting a code to the website to access some or all of the other user's control space. For example, the code may be provided to the user and emails, files, video, and the like may be associated with the code and presented to the user via the website.

In an example, an owner of a control space may distribute the code to other users via any suitable technique such as email, voice, text, or the like. The code may be sent to the other users along with a description of the purpose of the code, such as that it may be used for accessing data at an identified website. A recipient of the code may access the data at the website for presentation to the recipient via the website without download of the data. Other codes may be used for accessing various other data such that layers of security may be provided to more sensitive data. For example, data may be stored in various folders or sub-folders that also require codes for access thereto.

In another example, codes may also be distributed to users for access to a text conference. The code may be sent along with instructions on how to join the conference via a website. A server, such as the server 102, may administer the website and the conference and permit users to join the conference by use of the code. Text messages may be sent from user electronic devices by conventional text messaging, and the text messages may be displayed to other users via the website in real time. In this way, multiple users may text one another in a conference such that all conference members may view the text messages.

Capability not only exists for users to communicate data to one another, but a texting conference may be set up where users communicate text to each other in a conference setting. Also, users who are added to the texting conference, not as a logged participant, but as someone available to provide input and answer questions, can communicate input from a mobile device or a computer directly into the texting conference as though they were logged into the texting conference.

If notifications that are sent to mobile devices and computers are not received because of a malfunction (disconnected, hardware problems, battery problems, and the like), the user can still receive the notifications and data by using any other mobile device or computer. One of the main reasons for this is that the notifications are retained along with the data.

If a mobile device or a computer is replaced, for example, upgraded, the user's contact lists and day-to-day messages and data are not affected. The user may continue seamlessly with the new device or computer. One of the main reasons for this is that the methods and systems of the present disclosure are independent of the user's accessing device, computer, software, and hardware.

If two users are communicating through mobile voice and are disconnected because they are no longer in range, they can still continue to communicate through systems and methods of the present disclosure through texting as long as both have suitable wirefire access, although they are out of range for voice.

The architect identity (ID) can not only be used to assign to users, it can also be used to assign an ID to the user's single location (control space). This will allow owners of a control space to network with each other through their control spaces without having to develop their own network. Text, messages, and data can be communicated to any control space with a notification to a recipient or recipients at the control space.

The architect ID can also be assigned to products and services. Since the architect Identity is permanent with self-defining ownership, this can greatly reduce fraud, such as black marketing another person's product and service.

By design, a user cannot communicate messages and data to another user's control space. If a user requests a copy of another user's data, the data owner can allow the requesting user to retrieve a copy. Since each message and data unit can be protected, the requesting user will only have access to the requested data. If the owner of the data is not comfortable with this arrangement, the owner can have a copy of the data automatically archived outside of the control space when the data is first communicated to the control space. The owner only needs to allow requesting users to access to retrieve a copy of the data outside the control space.

By design it is impossible to spam another user without first spamming yourself. This is because a user cannot communicate data to another user's control space. Secondly, all physical data possessed by a user resides in that user's control space.

Every message and data unit can be protected in a control space. One great benefit of this is depicted in the following example. If a user steals access to another user control space and login to the space, the user may not have access to any messages or data in the space. The present disclosure gives users an option to limit access to messages and data by a login. The limit can be zero access to messages and data.

This present disclosure allows any video streaming enabled device, mobile or computer, to connect live with another user's device enabled with network video, such as a network video camera, and there is nothing special required in either device, mobile enabled streaming device or the network camera. There are some great benefits including, but not limited to, the network video device being used by an operator or a checkout clerk. The mobile device or computer can be used to shop over the Internet (business as usual). However, at checkout time, the shopper can select an option to check out with a live operator or clerk. The shopper's items (shopping cart) appear on the screen of the operator or clerk. A dialogue is enabled with voice and video. The shopper can see and hear the operator or clerk. The clerk can hear the shopper which has the same items on the screen. The clerk may or may not see the shopper since the shopper device is not required to have a video camera. Note also, this is not video conferencing which is used currently across the Internet and typically uses a camera on both ends. The shopper's personal information, especially the shopper's credit card information, is not entered on the Internet. The shopper simply gives the operator or clerk the credit card information to complete the process. Not only the shopper's personal information is not on the Internet, the shopper can take instant pictures during the checkout process, and these pictures are communicated automatically to the shopper's control space.

Embodiments of the present disclosure may be implemented on any suitable networked device, such as fax machines, copiers, and network cameras. These devices can add support to communicate data to a user control space.

In accordance with embodiments, the system described herein may be used as an event alert mechanism. An event can be communicated with an alert code by way of text message, an email, a mobile call, and a land call. One or all four alert types may be used.

Various systems that could benefit from the present disclosure include, but are not limited to, computer email providers, mobile device providers, and any computer or mobile software that provides login accounts.

In accordance with embodiments, example systems and methods may be used for communicating audio text in a conference setting. Users can communicate audio text directly into the conference. In addition, any user in the conference may select any audio text in the conference and listen.

Further, according to embodiments, commands for conferencing in conjunction with voice activation software, audio texting can also be implemented by speaking conferencing commands. For example, when a user speaks, recording may start, and when the user speaks: “audio conference send” command, recording may step, and the audio text may be automatically sent directly into the conference.

To listen to another user's audio text, a user may speak the ID of that user. A set of commands are provided to conduct a complete audio texting conference.

Exemplary benefits of speaking audio text conference include, but are not limited to, users speaking in their own language; users do not need a keyboard to type; and users do not need a display screen to view or to select the audio text.

Further, example systems and methods provide an option to protect each unit of data including text, such as videos, pictures, audio, text, documents, and the like). Each data unit can be assigned an ID and password. This feature is intended to be used with the retrieve data unit feature as described below.

In accordance with embodiments, a retrieve function can be used by owners of a control space to allow users to retrieve a data unit from their control space. The owner can assign an ID and a password to any data unit.

An example benefit of the retrieve feature includes providing that the owner of a data unit does not have to communicate the data unit to a large number of recipients. Each recipient can simply retrieve a copy.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs are may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

While the embodiments have been described in connection with various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A computer-implemented method for controlling data communications, the method comprising:
using at least one processor for:
receiving and storing data from a first electronic device;
controlling access to the data using a user control space;
managing the data using the user control space; and
communicating with a second electronic device using the user control space.

2. The method of claim 1, further comprising assigning an architected identification to a first user to enable use of the user control space.

3. The method of claim 2, further comprising using the architected identification to communicate with the second electronic device.

4. The method of claim 2, wherein the user control space is not accessible using personal or computer-identifiable information.

5. The method of claim 1, further comprising providing the first electronic device with predefined capability using the user control space.

6. The method of claim 5, wherein the predefined capability comprises at least one of voice communications, data communications, email messaging, text messaging, text conferencing, data archival, message archival, application execution, recipient notifications, and event alerts.

7. The method of claim 1, further comprising detecting and preventing one of receipt and storage of unauthorized data.

8. A computer-readable storage medium having computer program code embodied thereon, the computer program code for controlling data communications, the computer program code comprising:
instructions for receiving and storing data from a first electronic device;
instructions for controlling access to the data using a user control space;
instructions for managing the data using the user control space; and
instructions for communicating with a second electronic device using the user control space.

9. The computer-readable storage medium of claim 8, wherein the computer program code further comprises instructions for assigning an architected identification to a first user to enable use of the user control space.

10. The computer-readable storage medium of claim 9, wherein the computer program code further comprises instructions for using the architected identification to communicate with the second electronic device.

11. The computer-readable storage medium of claim 9, wherein the computer program code further comprises instructions for preventing access to the user control space by use of personal or computer-identifiable information.

12. The computer-readable storage medium of claim 8, wherein the computer program code further comprises instructions for providing the first electronic device with predefined capability using the user control space.

13. The computer-readable storage medium of claim 12, wherein the predefined capability comprises at least one of voice communications, data communications, email messaging, text messaging, text conferencing, data archival, message archival, application execution, recipient notifications, and event alerts.

14. The computer-readable storage medium of claim 8, wherein the computer program code further comprises instructions for detecting and preventing one of receipt and storage of unauthorized data.

15. A system for controlling data communications, the system comprising:
an input/output interface configured to communicate with a network; and
a communication manager configured to:
receive and store data from a first electronic device;
control access to the data using a user control space;
manage the data using the user control space; and
communicate with a second electronic device using the user control space.

16. The system of claim 15, wherein the communication manager is configured to assign an architected identification to a first user to enable use of the user control space.

17. The system of claim 16, wherein communication manager is configured to use the at least one architected identification to communicate with the at least one other electronic device.

18. The system of claim 16, wherein the communication manager is configured to prevent access to the user control space by use of personal or computer-identifiable information.

19. The system of claim 15, wherein the communication manager is configured to provide the first electronic device with predefined capability using the user control space.

20. The system of claim 19, wherein the predefined capability comprises at least one of voice communications, data communications, email messaging, text messaging, text conferencing, data archival, message archival, application execution, recipient notifications, and event alerts.

21. The system of claim 15, wherein the processing system is configured to detect and prevent one of receipt and storage of unauthorized data.
